(19) United States
(12) Patent Application Publication
(10) Pub. No.: US 2022/0237508 A1
(43) Pub. Date: Jul. 28, 2022

(54) SERVERS, METHODS AND SYSTEMS FOR SECOND ORDER FEDERATED LEARNING

(71) Applicants: Kiarash SHALOUDEGI, Côte Saint-Luc (CA); Rasul TUTUNOV, Cambridge (GB); Haitham BOU AMMAR, London (CA)

(72) Inventors: Kiarash SHALOUDEGI, Côte Saint-Luc (CA); Rasul TUTUNOV, Cambridge (GB); Haitham BOU AMMAR, London (CA)

(21) Appl. No.: 17/161,224

(22) Filed: Jan. 28, 2021

(51) Int. Cl. G06N 20/00; G06K 9/62; G06F 17/16; G06F 17/15

(52) U.S. Cl. CPC G06N 20/00; G06F 17/15; G06F 17/16; G06K 9/6277

(57) ABSTRACT

Servers, methods and systems for second order federated learning (FL) are described. Client nodes send local curvature information to the server along with local learned parameter information. The local curvature information enables the server to approximate or estimate the curvature, i.e. a second-order derivative, of an objective function of each respective local model. Instead of averaging the local learned parameter information obtained from the client nodes, the server uses the local curvature information to aggregate the local learned parameter information obtained from each client node to correct for the bias that would ordinarily result from a straightforward averaging of the learned values of the local learnable parameters. The described examples may provide reduced bias and/or reduced communication costs, relative to existing FL approaches such as federated averaging. The described examples may provide greater accuracy in model performance and/or faster convergence in FL.

### FIELD

The present disclosure relates to servers, method and systems for training of a machine learning-based model, in particular related to servers, methods and systems for performing second order federated learning.

### BACKGROUND

Federated learning (FL) is a machine learning technique in which multiple edge computing devices (also referred to as client nodes) participate in training a machine learning algorithm to learn a centralized global model (maintained at a server) without sharing their local data with the server. Such local data are typically private in nature (e.g., photos captured on a smartphone, or health data collected by a wearable sensor). FL helps with preserving the privacy of such local data by enabling the centralized global model to be trained (i.e., enabling the learnable parameters (e.g. weights and biases) of the centralized global model to be set to values that result in accurate performance of the centralized global model at inference) without requiring the client nodes to share their local data with the server. Instead, each client node performs localized training of a local copy of the global model (referred to as a “local model”) using a machine learning algorithm and its respective set of the local data (referred to as a “local dataset”) to learn values of the learnable parameters of the local model, and transmits information to be used to adjust the learned values of the learnable parameters of the centralized global model back to the server. The server adjusts the learned values of the learnable parameters of the centralized global model based on local learned parameter information received from each of the client nodes. Successful practical implementation of FL in real-world applications would enable the large amount of local data that is collected by client nodes (e.g. personal edge computing devices) to be leveraged for the purposes of training the centralized global model.

The amount of information passed back and forth between the server and the client nodes is referred to as a communication cost. Communication costs are typically the limiting factor, or at least a primary limiting factor, in practical implementation of FL. In existing approaches, each round of training involves communication of the adjusted current learned values of the learnable parameters of the global model from the server to each client node and communication of local learned parameter information from each client node back to the server. The greater the number of training rounds, the greater the communication costs. Typically, a model will be trained until the values of its learnable parameters converge on a set of values that do not change significantly in response to further training, which is referred to as “convergence” of the model's learnable parameter values (or simply “model convergence”). If a machine learning algorithm causes a model to converge in few rounds of training, the algorithm may be said to result in fast model convergence. Whereas machine learning in general has benefited from various approaches that seek to increase the speed of model convergence in the context of a single central model being trained locally, these existing approaches for achieving faster convergence of machine learning models may not be suitable for the unique context of FL.

A common approach for implementing FL is to average the learned parameters from each client node to arrive at a set of aggregated learned parameter values. Each client node sends information to the server, the information indicating learned parameter values of the respective local model. The server averages these sets of local learned parameter values to generate adjusted global learnable parameter values. In other words, each global learnable parameter p of the set of global learnable parameters w is adjusted to a value equal to the average of the corresponding local learned parameter values p₁, p₂, . . . p_{N} included in the local learned parameter information received from client node(1) through client node(N). In some embodiments, this averaging may be performed on the local learned parameter values w₁, w₂, . . . w_{N}; in other embodiments, the averaging may be performed on gradients of the local learned parameter values, yielding the same results as the averaging of the local learned parameter values themselves. An example of this averaging approach called “federated averaging” or “FedAvg” is described by B. McMahan, E. Moore, D. Ramage, S. Hampson and a. B. A. y. Arcas, “Communication-efficient learning of deep networks from decentralized data,” AISTATS, 2017.

However, because the local data included in the local datasets are not independent and identically distributed (i.i.d.), the learned values of the local learnable parameters of the respective local models will be biased toward their respective local datasets. This means that averaging local learned values for the learnable parameters received from client nodes can result in the values of the learnable parameters of the centralized global model inheriting these biases, leading to inaccurate performance of the centralized global model in performing the task for which it has been trained at inference.

In the specific context of FL, averaging approaches such as FedAvg may attempt to account for the bias described above using two techniques: first, client nodes may be configured to not fully fit their local models to the respective local datasets (i.e., local learned parameter values are not learned locally to the point of convergence), and second, training may take place in multiple rounds, with client nodes sending local learned parameter information to the server and receiving adjusted values for the learnable parameters of centralized global model from the server in each round, until the centralized global model converges on global learned parameter values that successfully mitigate the local bias. Both of these techniques increase the communication cost significantly, as convergence may require a large number of rounds of training and therefore large communication cost in order to mitigate the bias.

There therefore exists a need for approaches to federated learning that addresses at least some of the limitations described above, including the inferior accuracy of trained centralized global model at inference due to local bias and/or the large communication costs incurred in training centralized global model to mitigate the local bias toward their local datasets.

### SUMMARY

In various examples, the present disclosure presents federated learning servers, methods and systems that may provide reduced bias and/or reduced communication costs, relative to existing FL approaches such as federated averaging. The disclosed methods and systems may provide greater accuracy in model performance and/or faster convergence in FL.

Examples disclosed herein send local curvature information from the client nodes to the server along with local learned parameter information relating to the values of the local learned parameters. The local curvature information enables the server to approximate or estimate the curvature, i.e. a second-order derivative, of an objective function of each respective local model with respect to one or more of the local learned parameters. The objective function is a function that the centralized global model (referred to as the “global model”) seeks to optimize, such as a loss function, a cost function, or a reward function. Instead of averaging the local learned parameter information obtained from the client nodes, the server uses the local curvature information to aggregate the local learned parameter information obtained from each client node to mitigate the bias that would ordinarily result from a straightforward averaging of the local learned parameter values.

The present disclosure describes examples in the context of FL, however it should be understood that disclosed examples may also be adapted for implementation of any distributed optimization or distributed learning.

As used herein, the term “estimated”, “approximated”, or “approximate” applied to a value (including, e.g., a scalar, a vector, a matrix, a solution, a function, data, or information) indicates a version that is close to the actual value but may not be exactly identical. Similarly, generating an “approximate” value or an “estimated” value has the same meaning as “approximating” or “estimating” the value.

As used herein, the term “adjust” refers to changing one or more values of an item, whether by replacing the old value with a new value, altering the old value to result in a new value, or otherwise causing the old value to take on a new value. The terms “adjust a model”, “adjust parameters of a model”, and “adjust the values of parameters of a model” are all used interchangeably herein to refer to adjusting the values of more or more values of learnable parameters of a model (e.g., a local model or the global model). When the values of learnable parameters are adjusted as the result of learning or training, the adjustment may be referred to as adjusting the “learned value” of the learnable parameter. The value of a learnable parameter that has been adjusted as a result of learning or training may be referred to as a “learned value” of the learnable parameter. Adjusting or generating a value of a learnable parameter may be referred to herein as adjusting or generating the learnable parameter. A “learned parameter” refers to the learned value of a learnable parameter.

As used herein, a “value” may refer to a scalar value, a vector value, or another value. A “set of values” may refer to a set of one or more scalar values (such as a vector), a set of one or more vector values, or any other set of one or more values.

In an aspect, the present disclosure describes a method for training a global model using federated learning in a system comprising a plurality of local models stored at a plurality of respective client nodes. The global model and each local model are trained to perform the same task. Each local model has a plurality of local learned parameters with values based on a respective local dataset of the respective client node. Local learned parameter information relating to the plurality of local learned parameters of the respective local model and local curvature information of an objective function of the respective local model are obtained from each client node. The local learned parameter information and local curvature information obtained from each client node are processed to generate a plurality of adjusted global learned parameters for the global model.

By using curvature information to adjust the global model, local bias resulting from the use of local datasets for federated learning may be mitigated in the learned values of the learnable parameters of the global model, potentially increasing model convergence speed, reducing communications costs, and/or resulting in greater accuracy of the prediction performance of the global model in prediction mode.

In another aspect, the present disclosure describes a system including a server and a plurality of client nodes. The server includes a processing device and a memory in communication with the processing device. The memory stores a global model trained to perform a task. The global model comprises a plurality of stored global learned parameters. The memory stores processor executable instructions for training the global model using federated learning. The processor executable instructions, when executed by the processing device, cause the server to carry out a number of steps. Local learned parameter information relating to the plurality of local learned parameters of the respective local model and local curvature information of an objective function of the respective local model are obtained from each client node. The local learned parameter information and local curvature information obtained from each client node are processed to generate a plurality of adjusted global learned parameters for the global model. The plurality of adjusted global learned parameters are stored in the memory as the plurality of stored global learned parameters. Each client node comprises a memory storing a respective local dataset and the respective local model. The local model is trained to perform the same task as the global model and comprises the respective plurality of local learned parameters based on the local dataset.

In another aspect, the present disclosure describes a server including a processing device and a memory in communication with the processing device. The memory stores a global model trained to perform a task. The global model comprises a plurality of stored global learned parameters. The memory stores processor executable instructions for training the global model using federated learning. The processor executable instructions, when executed by the processing device, cause the server to carry out a number of steps. Local learned parameter information relating to the plurality of local learned parameters of the respective local model and local curvature information of an objective function of the respective local model are obtained from each client node. The local learned parameter information and local curvature information obtained from each client node are processed to generate a plurality of adjusted global learned parameters for the global model. The plurality of adjusted global learned parameters are stored in the memory as the plurality of stored global learned parameters.

In any of the above aspects, the local curvature information obtained from a respective client node comprises a first Hessian-vector product based on the plurality of local learned parameters of the respective local model and a Hessian matrix, the Hessian matrix comprising second-order partial derivatives of the objective function of the respective local model with respect to the plurality of local learned parameters.

By sending a Hessian-vector product instead of a full Hessian matrix from the client node to the server, communications costs may be reduced from O(n²) to O(n), where n is the number of client nodes.

In any of the above aspects, the local curvature information received from each client node further comprises a set of diagonal elements of the Hessian matrix of the respective local model.

By sending the diagonal elements of the Hessian matrix, the client node may provide the server with sufficient information to approximate the Hessian vector while maintaining communication costs at O(n).

In any of the above aspects, processing the local learned parameter information and local curvature information obtained from each client node comprises: for each local model, generating an estimated curvature of the objective function of the respective local model based on the local learned parameter information of the respective local model and the set of diagonal elements of the Hessian matrix of the respective local model, and generating the plurality of adjusted global learned parameters for the global model based on the estimated curvatures of the objective functions of each of the plurality of local models.

In any of the above aspects, the plurality of adjusted global learned parameters are generated by performing quadratic optimization based on the estimated curvature and first Hessian-vector product of each local model.

By using quadratic optimization, the server may solve a system of linear equations efficiently to find a desirable or optimal set of values for the global learnable parameters.

In any of the above aspects, performing the quadratic optimization comprises solving the equation w= [symbol] ∥ΣᵢαᵢĤx−Σᵢαᵢbᵢ∥₂² wherein w is the plurality of adjusted global learned parameters, i is an index value corresponding to a client node of the plurality of client nodes, αᵢ is a weight assigned to the client node having index value i, Ĥᵢ is a matrix representing the estimated curvature based on the diagonal elements of the Hessian matrix of the client node having index value i, and bᵢ is the first Hessian-vector product obtained from the client node having index value i.

In any of the above aspects, obtaining the local curvature information from each client node comprises obtaining, from the respective client node, the first Hessian-vector product, and repeating two or more times the steps of sending, to the respective client node, a parameter vector comprising a plurality of global learned parameters of the global model, and obtaining, from the respective client node, a second Hessian-vector product based on the Hessian matrix of the respective local model and the parameter vector.

By using multiple rounds of bidirectional communication between the client node and server, an exact solution may be found to an optimization problem with respect to the global learned parameter values.

In any of the above aspects, generating the plurality of adjusted global learned parameters comprises repeating two or more times the step of, in response to obtaining the second Hessian-vector product from each client node, performing quadratic optimization using the first Hessian-vector product of each client node and the second Hessian-vector product of each client node to generate the plurality of adjusted global learned parameters. Generating the parameter vector such that the parameter vector comprises the plurality of adjusted global learned parameters.

In any of the above aspects, performing the quadratic optimization comprises solving the minimization problem: minimize ∥ΣᵢαᵢHᵢx−Σᵢαᵢbᵢ∥₂², wherein x is the plurality of adjusted global learned parameters, i is an index value corresponding to a client node of the plurality of client nodes, αᵢ is a weight assigned to the client node having index value i, Hᵢx is the second Hessian-vector product obtained from the client node having index value i, and bᵢ is the first Hessian-vector product obtained from the client node having index value i.

In any of the above aspects, the local curvature information obtained from each client node further comprises a gradient vector comprising a plurality of gradients of the objective function of the local model of the respective client node. The method further comprises, for each client node, storing the gradient vector obtained from the respective client node in the memory as a stored gradient vector of the respective client node.

By using local gradients to optimize the global learned parameter values, the calculations performed at each client node may be kept relatively simple, and communication costs may be further reduced relative to other approaches.

In any of the above aspects, processing the local learned parameter information and local curvature information obtained from each client node comprises retrieving, from a memory, a plurality of stored global learned parameters of the global model; for each local model, retrieving, from the memory, a stored gradient vector of the respective local model, and generating an estimated curvature of the objective function of the respective local model based on the local learned parameter information of the respective local model, the gradient vector obtained from the respective client node, the plurality of previous global learned parameters of the global model, and the stored gradient vector of the respective local model; and performing quadratic optimization to generate the plurality of adjusted global learned parameters for the global model based on the estimated curvatures of the objective functions of each of the plurality of local models and the first Hessian-vector product obtained from each of the plurality of client nodes, and storing the adjusted global learned parameters in the memory as the stored global learned parameters of the global model.

In any of the above aspects, generating the estimated curvature of a client node comprises applying a quasi-Newton method to generate an estimated Hessian matrix of the local model of the client node based on the gradient vector obtained from the client node, the stored global learned parameters, and the stored gradient vector for the client node.

By using a quasi-Newton method, the server may efficiently approximate curvature of local loss functions based on local gradients without access to the Hessian matrix for each local model.

In any of the above aspects, performing the quadratic optimization comprises solving the equation: w= [symbol] ∥Σᵢαᵢx−Σᵢαᵢbᵢ∥₂² wherein w is the plurality of adjusted global learned parameters, i is an index value corresponding to a client node of the plurality of client nodes, αᵢ is a weight assigned to the client node having index value i, Hᵢ is a matrix representing the estimated curvature of the objective function of the local model of the client node having index value i, and bᵢ is the first Hessian-vector product obtained from the client node having index value i.

In any of the above aspects, the method further comprises, prior to obtaining the local learned parameter information and local curvature information from the plurality of client nodes, retrieving, from a memory, a plurality of stored global learned parameters of the global model, generating global model information comprising values of the plurality of global learnable parameters, and sending the global model information to each client node.

In any of the above examples, each client node further comprises a processing device. The memory of each client node further stores processor executable instructions that, when executed by the client's processing device, cause the client node to retrieve the plurality of local learned parameters from the memory of the client node, generate the local curvature information of an objective function of the local model, generate the local learned parameter information based on the plurality of local learned parameters, and send the local learned parameter information and local curvature information to the server.

In any of the above examples, the local curvature information generated by a respective client node comprises a first Hessian-vector product based on the plurality of local learned parameters of the respective local model and a Hessian matrix. The Hessian matrix comprises second-order partial derivatives of the objective function of the respective local model with respect to the plurality of local learned parameters.

In any of the above examples, the local curvature information generated by each client node further comprises a set of diagonal elements of the Hessian matrix of the respective local model.

In any of the above examples, the local curvature information generated by each client node further comprises a gradient vector comprising a plurality of gradients of the objective function of the local model of the respective client node. The server's processor executable instructions, when executed by the server's processing device, further cause the server to, for each client node, store the gradient vector obtained from the respective client node in the server's memory as a stored gradient vector of the respective client node.

In some examples, the present disclosure describes a computer-readable medium having instructions stored thereon, wherein the instructions, when executed by a processing device of an apparatus, cause the apparatus to perform any of the methods described above.

### BRIEF DESCRIPTION OF THE DRAWINGS

Reference will now be made, by way of example, to the accompanying drawings which show example embodiments of the present application, and in which:

FIG. 1 is a block diagram of an example system that may be used to implement federated learning;

FIG. 2A is a block diagram of an example server that may be used to implement examples described herein;

FIG. 2B is a block diagram of an example client node that may be used as part of examples described herein;

FIG. 3 is a graph of a learned parameter value x against a first objective function f₁(x) of a first local model, a second objective function f₂(x) of a second local model, and a combined objective function equal to f₁(x)+f₂(x), illustrating the bias introduced by existing approaches in contrast to bias correction performed by examples described herein;

FIG. 4 is a block diagram illustrating information flows of a general example of a federated learning module using local curvature information in accordance with examples described herein;

FIG. 5 is a block diagram illustrating information flows of a first example embodiment of the general federated learning module of FIG. 4 using local curvature information including diagonal Hessian matrix elements;

FIG. 6 is a block diagram illustrating information flows of a second example embodiment of the general federated learning module of FIG. 4 using multiple rounds of bidirectional communication of parameter vectors and Hessian-vector products between the client nodes and the server;

FIG. 7 is a block diagram illustrating information flows of a third example embodiment of the general federated learning module of FIG. 4 using curvature information including gradient vectors;

FIG. 8 shows steps of a first example method for training a global model using federated learning, in accordance with examples described herein;

FIG. 9 shows steps of a second example method for training a global model using federated learning using multiple rounds of bidirectional communication of parameter vectors and Hessian-vector products between the client nodes and the server, in accordance with examples described herein; and

FIG. 10 shows steps of a third example method for training a global model using federated learning using curvature information including gradient vectors, in accordance with examples described herein.

Similar reference numerals may have been used in different figures to denote similar components.

### DESCRIPTION OF EXAMPLE EMBODIMENTS

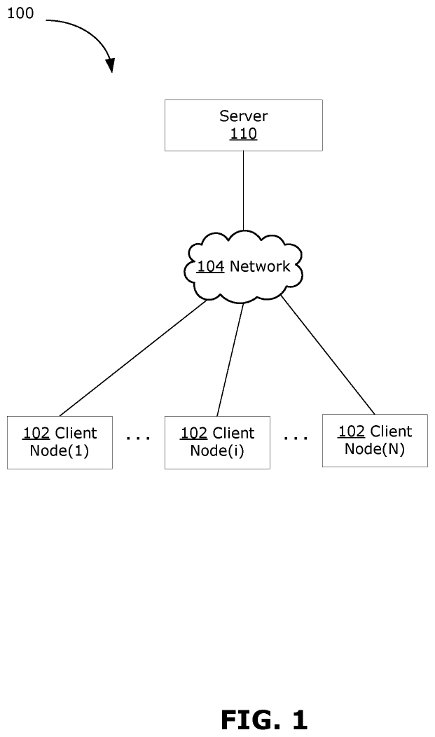

In examples disclosed herein, methods and systems are described that help to enable practical application of federated learning (FL). The disclosed examples may help to address challenges that are unique to FL. To assist in understanding the present disclosure, FIG. 1 is first discussed.

FIG. 1 illustrates an example system 100 that may be used to implement FL. The system 100 has been simplified in this example for ease of understanding; generally, there may be more entities and components in the system 100 than that shown in FIG. 1.

The system 100 includes a plurality of client nodes 102, each of which collects and stores respective sets of local data (also referred to as local datasets). Each client node 102 can run a machine learning algorithm to learn values of learnable parameters of a local model using a set of local data (also called a local dataset). For the purposes of the present disclosure, running a machine learning algorithm at a client node 102 means executing computer-readable instructions of a machine learning algorithm to adjust the values of the learnable parameters of a local model. Examples of machine learning algorithms include supervised learning algorithms, unsupervised learning algorithms, and reinforcement learning algorithms. For generality, there may be N client nodes 102 (N being any integer larger than 1) and hence N sets of local data (also called local datasets). The local datasets are typically unique and distinct from each other, and it may not be possible to infer the characteristics or distribution of any one local dataset based on any other local dataset. A client node 102 may be an edge device, an end user device (which may include such devices (or may be referred to) as a client device/terminal, user equipment/device (UE), wireless transmit/receive unit (WTRU), mobile station, fixed or mobile subscriber unit, cellular telephone, station (STA), personal digital assistant (PDA), smartphone, laptop, computer, tablet, wireless sensor, wearable device, smart device, machine type communications device, smart (or connected) vehicles, or consumer electronics device, among other possibilities), or may be a network device (which may include (or may be referred to as) a base station (BS), router, access point (AP), personal basic service set (PBSS) coordinate point (PCP), eNodeB, or gNodeB, among other possibilities). In the case wherein a client node 102 is an end user device, the local dataset at the client node 102 may include local data that is collected or generated in the course of real-life use by user(s) of the client node 102 (e.g., captured images/videos, captured sensor data, captured tracking data, etc.). In the case wherein a client node 102 is a network device, the local data included in the local dataset at the client node 102 may be data that is collected from end user devices that are associated with or served by the network device. For example, a client node 102 that is a BS may collect data from a plurality of user devices (e.g., tracking data, network usage data, traffic data, etc.) and this may be stored as local data in the local dataset on the BS.

The client nodes 102 communicate with the server 110 via a network 104. The network 104 may be any form of network (e.g., an intranet, the Internet, a P2P network, a WAN and/or a LAN) and may be a public network. Different client nodes 102 may use different networks to communicate with the server 110, although only a single network 104 is illustrated for simplicity.

The server 110 may be used to train a centralized global model (referred to hereinafter as a global model) using FL. The term “server”, as used herein, is not intended to be limited to a single hardware device: the server 110 may include a server device, a distributed computing system, a virtual machine running on an infrastructure of a datacenter, or infrastructure (e.g., virtual machines) provided as a service by a cloud service provider, among other possibilities. Generally, the server 110 (including the federated learning module 200 discussed further below) may be implemented using any suitable combination of hardware and software, and may be embodied as a single physical apparatus (e.g., a server device) or as a plurality of physical apparatuses (e.g., multiple machines sharing pooled resources such as in the case of a cloud service provider). The server 110 may implement techniques and methods to learn values of the learnable parameters of the global model using FL as described herein.

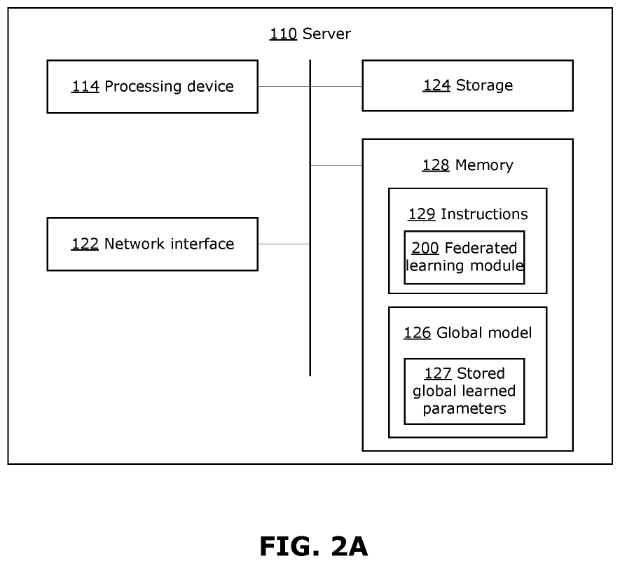

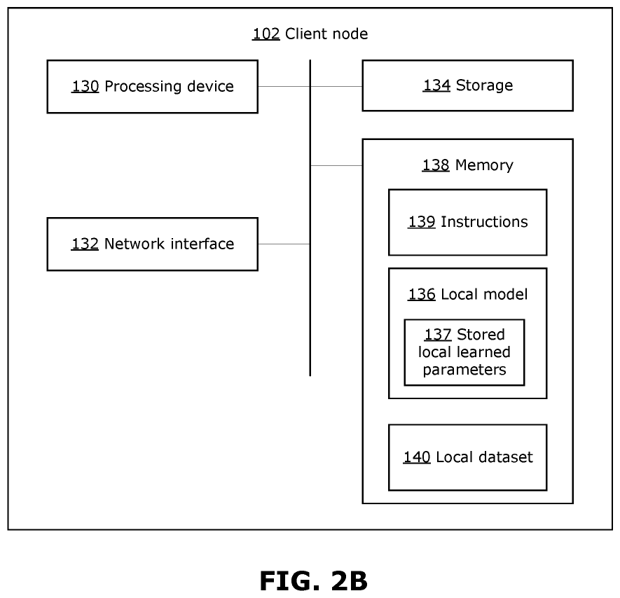

FIG. 2A is a block diagram illustrating a simplified example implementation of the server 110. Other examples suitable for implementing embodiments described in the present disclosure may be used, which may include components different from those discussed below. Although FIG. 2A shows a single instance of each component, there may be multiple instances of each component in the server 110.

The server 110 may include one or more processing devices 114, such as a processor, a microprocessor, a digital signal processor, an application-specific integrated circuit (ASIC), a field-programmable gate array (FPGA), a dedicated logic circuitry, a dedicated artificial intelligence processor unit, a tensor processing unit, a neural processing unit, a hardware accelerator, or combinations thereof.

The server 110 may include one or more network interfaces 122 for wired or wireless communication with the network 104, the client nodes 102, or other entity in the system 100. The network interface(s) 122 may include wired links (e.g., Ethernet cable) and/or wireless links (e.g., one or more antennas) for intra-network and/or inter-network communications.

The server 110 may also include one or more storage units 124, which may include a mass storage unit such as a solid state drive, a hard disk drive, a magnetic disk drive and/or an optical disk drive.

The server 110 may include one or more memories 128, which may include a volatile or non-volatile memory (e.g., a flash memory, a random access memory (RAM), and/or a read-only memory (ROM)). The non-transitory memory(ies) 128 may store processor executable instructions 129 for execution by the processing device(s) 114, such as to carry out examples described in the present disclosure. The memory(ies) 128 may include other software stored as processor executable instructions 129, such as for implementing an operating system and other applications/functions. In some examples, the memory(ies) 128 may include processor executable instructions 129 for execution by the processing device 114 to implement a federated learning module 200 (for performing FL), as discussed further below. In some examples, the server 110 may additionally or alternatively execute instructions from an external memory (e.g., an external drive in wired or wireless communication with the server) or may be provided processor executable instructions by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage.

The memory(ies) 128 may also store a global model 126 trained to perform a task. The global model 126 includes a plurality of learnable parameters 127 (referred to as “global learnable parameters” 127), such as learned weights and biases of a neural network, whose values may be adjusted during the training process until the global model 126 converges on a set of global learned parameter values representing an optimized solution to the task which the global model 126 is being trained to perform. In addition to the global learnable parameters 127, the global model 126 may also include other data, such as hyperparameters, which may be defined by an architect or designer of the global model 126 (or by an automatic process) prior to training, such as at the time the global model 126 is designed or initialized. In machine learning, hyperparameters are parameters of a model that are used to control the learning process; hyperparameters are defined in contrast to learnable parameters, such as weights and biases of a neural network, whose values are adjusted during training.

FIG. 2B is a block diagram illustrating a simplified example implementation of a client node 102. Other examples suitable for implementing embodiments described in the present disclosure may be used, which may include components different from those discussed below. Although FIG. 2B shows a single instance of each component, there may be multiple instances of each component in the client node 102.

The client node 102 may include one or more processing devices 130, one or more network interfaces 132, one or more storage units 134, and one or more non-transitory memories 138, which may each be implemented using any suitable technology such as those described in the context of the server 110 above.

The memory(ies) 138 may store processor executable instructions 139 for execution by the processing device(s) 130, such as to carry out examples described in the present disclosure. The memory(ies) 138 may include other software stored as processor executable instructions 139, such as for implementing an operating system and other applications/functions. In some examples, the memory(ies) 138 may include processor executable instructions 139 for execution by the processing device 130 to implement client-side operations of a federated learning system in conjunction with the federated learning module 200 executed by the server 110, as discussed further below.

The memory(ies) 138 may also store a local model 136 trained to perform the same task as the global model 126 of the server 110. The local model 136 includes a plurality of learnable parameters 137 (referred to as “local learnable parameters” 137), such as learned weights and biases of a neural network, whose values may be adjusted during a local training process based on the local dataset 140 until the local model 136 converges on a set of local learned parameter values representing an optimized solution to the task which the local model 136 is being trained to perform. In addition to the local learnable parameters 137, the local model 136 may also include other data, such as hyperparameters matching those of the global model 126 of the server 110, such that the local model 136 has the same architecture and operational hyperparameters as the global model 126, and differs from the global model 126 only in the values of its local learnable parameters 137, i.e. the values of the local learnable parameters stored in the memory 138 after local training are stored as the learned values of the local learnable parameters 137.

Federated learning (FL) is a machine learning technique that may be confused with, but is clearly distinct from, distributed optimization techniques. FL exhibits unique features (and challenges) that distinguish FL from general distributed optimization techniques. For example, in FL, the numbers of client nodes involved is typically much higher than the numbers of client nodes in most distributed optimization problems. As well, in FL, the distribution of the local data collected at respective different client nodes are typically non-identical (this may be referred to as the local data at different client nodes having non-i.i.d. distribution, where i.i.d. means “independent and identically distributed”). In FL, there may be a large number of “straggler” client nodes (meaning client nodes that are slower-running, which are unable to send updates to a central node in time and which may slow down the overall progress of the system). Also, in FL, the amount of local data collected and stored on respective different client nodes may differ significantly among different client nodes (e.g., differ by orders of magnitude). These are all features of FL that are typically not found in general distributed optimization techniques, and that introduce unique challenges to practical implementation of FL. In particular, the non-i.i.d. distribution of local data across different client nodes means that many algorithms that have been developed for distributed optimization may not be suitable for use in FL.

Typically, FL involves multiple rounds of training, each round involving communication between the server 110 and the client nodes 102. An initialization phase may take place prior to the training phase. In the initialization phase, the global model is initialized and information about the global model (including the model architecture, the machine learning algorithm that is to be used to learn the values of the learnable parameters of the global model, etc.) is communicated by the server 110 to all of the client nodes 102. At the end of the initialization phase, the server 110 and all of the client nodes 102 each have the same initialized model (i.e. the global model 126 and each local model 136 respectively), with the same architecture, same hyperparameter, and same learnable parameters. After initialization, the training phase may begin.

During a round of training in the training phase, information relating to the global and local learnable parameters 127, 137 of the models 126, 136, including local curvature information relating to the curvature of the objective function of a local model 136 relative to one or more local learnable parameters, is communicated between the client nodes 102 and the server 110. A single round of training is now described. At the beginning of the round of training, the server 110 retrieves, from the memory 128, the stored learned values of the global learnable parameters 127 of the global model 126, generates global model information comprising the values of the global learnable parameters 127, and sends the global model information to each of a plurality of client nodes 102 (e.g., a selected fraction from the total client nodes 102). For example, the global model information may consist entirely of the values of the global learnable parameters 127 of the global model 126, because the other information defining the global model 126 (e.g. a model architecture, the machine learning algorithm, and the hyperparameters) is already identical to that of each local model 136 due to operations already performed during the initialization phase.

The current global model may be a previously adjusted global model (e.g., the result of a previous round of training). Each selected client node 102 receives the global model information, stores the values of the global learnable parameters 127 as the values of the local learnable parameters 137 in the memory 138 of the client node 102) and uses its respective local dataset 140 to train the local model 136, using a machine learning algorithm defined by processor executable instructions 139 stored in the client node memory 138 and executed by the client node's processor device 130. The training of the local model 136 is performed using an objective function that defines the degree to which the output of the local model 136 in response to an input (i.e. a sample selected from the local dataset 140) satisfies an objective, such as a learning goal. The learning goal may be measured, for example, by measuring the accuracy or effectiveness of the predictions made or actions taken by the local model 136. Examples of objective functions include loss functions, cost functions, and reward functions. The objective function may be defined negatively (i.e., the greater the value generated by the objective function, the less the degree to which the objective is satisfied, as in the case of a loss function or cost function), or positively (i.e., the greater the value generated by the objective function, the greater the degree to which the objective is satisfied, as in the case of a reward function). The objective function may be defined by hyperparameters of the local model 136. The objective function may be regarded as function of the local learnable parameters 137, and like any function may be used to compute or estimate a first-order partial derivative (i.e. a slope) or a second-order partial derivative (i.e. a curvature). The second-order partial derivative of the objective function of the local model 136 with respect to one or more local learnable parameters 137 may be referred to as the “curvature” of the objective function or the local model 136, or as the “local curvature” of a respective client node 102.

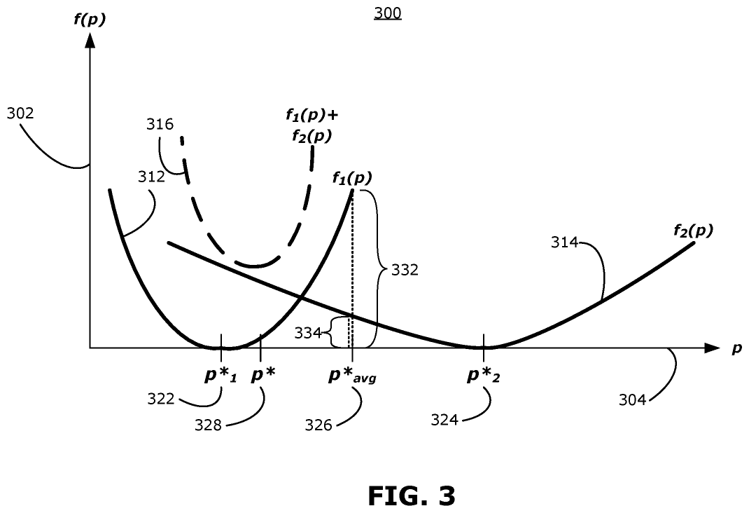

Example embodiments disclosed herein may make use of information relating to the local curvature of the local models 136 of the system 100 to improve the accuracy of the global model 126 by accounting for local bias. An example of mitigating local bias using the information relating to the local curvature of the local models 136 of the system 100 (referred to hereinafter as “local curvature information”) is shown in FIG. 3.

FIG. 3 is a graph 300 of a local learnable parameter p (mapped to the horizontal axis 304) against a first objective function f₁(p) 312 of a first local model and a second objective function f₂(p) 314 of a second local model mapped onto the vertical axis 302. In this example, the objective functions f₁(p) 312 and f₂(p) 314 are defined negatively (i.e., they may be regarded as loss functions or cost functions). The objective functions f₁(p) 312 and f₂(p) 314 have stationary points (i.e. local minima, or local maxima in the case of a positively-defined objective function such as a reward function) at p=p*₁ 322 and p=p*₂ 324, respectively. These stationary points 322, 324 indicate that, during the training phase of the local models, the learned value for the local learnable parameter p converges at p=p*₁ 322 in the first local model (stored at a first client node) based on the respective local dataset 140 of the first client node, and the learned value for the local learnable parameter p converges at p=p*₂ 324 in the second local model (stored at a second client node) based on the respective local dataset 140 of the second client node.

A conventional averaging approach, such as federated averaging, sends information from the client nodes to the server 110 indicating the respective stationary points 322, 324 as indicating the adjusted local learned parameter values for learned parameter p. The server 110 then averages these values to compute p=p*_{avg} 326 as the value of the global learnable parameter p of the global model, indicated as the mid-point between p=p*₁ 322 and p=p*₂ 324 on the horizontal axis 304.

However, it will be appreciated that the value p=p*_{avg} 326 for the global model 126, when communicated back to the client nodes 102, will result in a significant loss or cost 332 when the first objective function f₁(p) 312 (a cost function or loss function in this example) is applied in the context of the first local model, whereas it will result in a much more modest loss or cost 334 when the second objective function f₂(p) 314 (also a cost function or loss function in this example) is applied in the context of the second local model. This disparity is due to the high degree of curvature of the first objective function f₁(p) 312 relative to the relatively modest curvature of the second objective function f₂(p) 314, and this disparity in the respective losses or costs of the two local models is an illustration of the local bias described above. This means that the adjusted learned parameter values of the global model 126 will result in inaccurate task performance by the first local model based on the local dataset 140 of the first client node 102(1), and it means that the federated learning process will require many rounds of learning and communication of global model information and local learned parameter information between the client node 102(1) and the server 110 to achieve convergence.

Thus, instead of averaging the values of the local learnable parameter p at the stationary points 322, 324 as in a federated averaging approach, example embodiments described herein use information regarding the curvature of local objective functions of the various client nodes 102 to aggregate the values of the local learnable parameter p obtained from the respective client nodes 102 into a more accurate and un-biased value of the global learnable parameter. In some embodiments, the goal of such aggregation may be to generate a global objective function 316 for the global model 126 that approximates the sum of f₁(p)+f₂(p), taking into account the curvature of first objective function f₁(p) 312 and second objective function f₂(p) 314, and resulting in a desired or optimal stationary point p=p* 328 for the global objective function 316 that minimizes overall total loss or cost (or maximizes the overall total reward) as between the two local objective functions 312, 314.

Thus, the problem being solved by FL may be characterized as follows: given a collection of client nodes 102 {1, . . . , N} such that each client node i has associated local dataset Dᵢ and objective function ƒᵢ(x;Dᵢ), the overall goal of a FL system is to solve the following optimization problem and compute x*:

$${x}^{*} = {arg min}_{x ∈ {ℝ}^{p}} \frac{1}{N} {\sum }_{i}^{N} {f}_{i} ( x ; {D}_{i} ) \qquad ( Equation 1 )$$

wherein p is one of the local learnable parameters included in a set of local learnable parameters 127 x, and p* is the value of the local learnable parameter p at overall stationary point x* (i.e. at a set of values x* for the set of learned parameters x that is a stationary point of the global objective function f(x)).

The averaging approach described above and applied in FIG. 3 to compute p=p*_{avg} 326 may be performed as follows: assume each client device 102 computes its local stationary points xᵢ* such that:

∇ƒᵢ(xᵢ*;Dᵢ)=0 for all i∈{1, . . . ,N} (Equation 2)

The server 110 obtains these local stationary points from the client nodes 102 and averages them:

$${x}_{a v g}^{*} = \frac{1}{N} {\sum }_{i}^{N} {x}_{i}^{*} \qquad ( Equation 3 )$$

However, as shown and described above with reference to FIG. 3, even if the objective functions ƒᵢ are convex, x_{avg}* is not the true minimizer of (Equation 1) above. What makes the stationary points {x₁*, . . . , x_{N}*} different from one another is that each local stationary point xᵢ* (such as the stationary points defining p*₁ 322 and p*₂ 324) is biased toward its respective local dataset 140, and unless the local datasets are the same, the stationary points will be different from one another. As described above, existing approaches attempt to address this bias problem by having client nodes 102 avoid fully fitting their local models 136 to their respective local datasets 140, and by performing many rounds of training wherein global model information and local model information are sent back and forth between the client nodes 102 and the server 110 until the global model 126 converges, thereby significantly increasing communication costs. However, even after many rounds of training, including many rounds of communication of the global model information and local model information, the final learned values of the global learnable parameters 137 may not converge to the optimal solution x*.

As described above, communication between the server 110 and the client nodes 102 is associated with communication cost. Communication and its related costs is a challenge that may limit practical application of FL. Communication cost can be defined in various ways. For example, communication cost may be defined in terms of the number of rounds required to adjust the values of the global learnable parameters of the global model until the global model reaches an acceptable performance level. Communication cost may also be defined in terms of the amount of information (e.g., number of bytes) transferred between the global and local models before the global model converges to a desired solution (e.g., the learned values of the global learnable parameters approximate x* closely enough to satisfy an accuracy metric, or the learned values of the global learnable parameters do not significantly change in response to further federated learning). Generally, it is desirable to reduce or minimize the communication cost, in order to reduce the use of network resources, processing resources (at the client nodes 102 and/or the server 110) and/or monetary costs (e.g., the monetary cost associated with network use), thereby improving the functioning of the system 100 and its component parts (e.g. the server 110 and client nodes 102).

Reducing communication rounds in the context of stochastic optimization is usually achieved through developing variance reduction techniques. In the optimization literature, there are examples of variance reduction techniques that work well in the context of traditional distributed optimization such as Distributed Approximate NEwton (DANE) (e.g., as described by Shamir et al. in “Communication-efficient distributed optimization using an approximate newton-type method,” ICML, 2014) and Stochastic Variance Reduced Gradient (SVRG) (e.g., as described by Johnson et al. in “Accelerating stochastic gradient descent using predictive variance reduction,” NIPS, 2013). However, variance reduction techniques that have been developed for traditional distributed optimization are not suitable for use in FL, because FL has unique challenges (such as the non-i.i.d. nature of the local data stored at different client nodes 102).

Another challenge in FL is the problem of bias among client nodes 102, as described above. One of the problems that may be overcome by embodiments described herein is to mitigate the bias in the global learned parameter values toward certain local models 136 (such as the second local model with objective function f₂(p) in FIG. 3), and therefore toward local datasets 140. The bias is an artifact of federated learning: in a centralized machine learning system, training a single model using a single dataset containing the contents of all the respective local datasets 140, the bias would not exist. Instead, the bias results from the naïve aggregation of the learned values of the learnable parameters of the local models 136 (e.g., using weighted averaging of learned values of the learnable parameters).

In example embodiments provided herein, a method for FL is described in which local curvature information relating to the local models is used by the server 100 such that the update of the global model drives the trained global model towards a solution that is not biased towards any client node 102, but instead achieves a good solution to ƒ(x)=Σƒᵢ(x) (i.e., the global objective function). Such an approach may mitigate bias in the global model, enable efficient convergence of the global model, and/or enable efficient use of network and processing resources (e.g., processing resources at the server 110, processing resources at each selected client node 102, and wireless bandwidth resources at the network), thereby improving the operation of the system 100 and its component computing devices such as server 110 and client nodes 102.

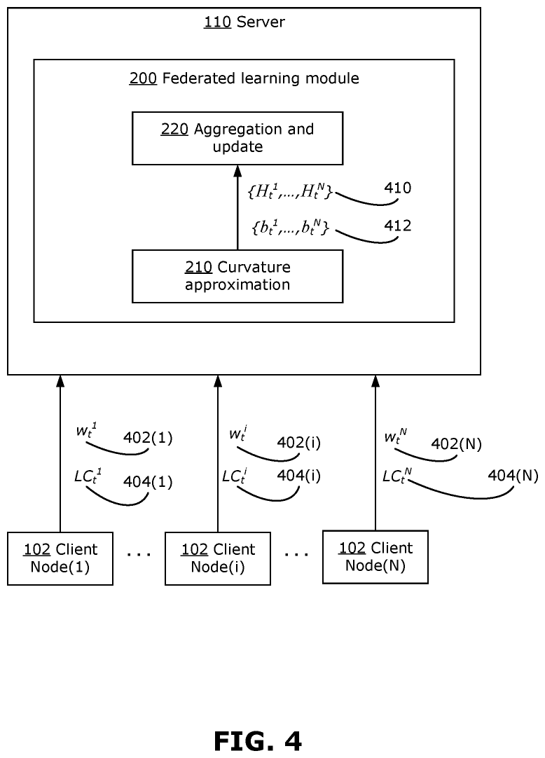

A general example of a system for performing federated learning using local curvature information will now be described with reference to FIG. 4.

FIG. 4 is a block diagram illustrating some details of a federated learning module 200 implemented in the server 110. For simplicity, the network 104 has been omitted from FIG. 4. The federated learning module 200 may be implemented using software (e.g., instructions for execution by the processing device(s) 114 of the server 110), using hardware (e.g., programmable electronic circuits designed to perform specific functions), or combinations of software and hardware.

To assist in understanding the present disclosure, some notation is introduced. As previously introduced, N is the number of client nodes 102. Although not all of the client nodes 102 may necessarily participate in a given round of training, for simplicity it will be assumed that N client nodes 102 participate in a current round of training, without loss of generality. Values relevant to a current round of training are denoted by the subscript t, values relevant to the previous round of training are denoted by the subscript t−1, and values relevant to the next round of training are denoted by the subscript t+1. The global learnable parameters 127 of the global model 126 (stored at the server 110) whose values are learned in the current round of training is denoted by wₜ. The local learnable parameters 137 of the local model whose values are learned at the i-th client node 102 in the current round of training is denoted by wⁱₜ; and the local learned parameter information obtained from the i-th client node 102 in the current round of training may be in the form of a gradient vector denoted by gₜⁱ or a local learned parameter vector denoted by wₜⁱ, where i is an index from 1 to N, to indicate the respective client node 102. The gradient vector (also referred to as the update vector or simply the update) gₜⁱ is generally computed as the difference between the values of the global learned parameters of the global model that was sent to the client nodes 102 at the start of the current round of training (which may be denoted as wₜ₋₁, to indicate that the global model was the result of a previous round of training) and the learned local model wⁱₜ (learned using the local dataset at the i-th client node). In particular, the gradient vector gₜⁱ may be computed by taking the difference or gradient between the local learned parameters (e.g., weights) of the learned local model wⁱₜ and the global learned parameters of the previous global model wₜ₋₁. As described above, the local learned parameter information may include a gradient vector or a local learned parameter vector: the gradient vector gₜⁱ may be computed at the i-th client node 102 and transmitted to the server 110, or the i-th client node 102 may transmit local learned parameter information 402 about the learnable parameters 137 of its local model 136 to the server 110 (e.g., the values wⁱₜ of the local learnable parameters 137 of the local model 136). If the local learned parameter vector is sent, the server 110 may perform a computation to generate a corresponding gradient vector gₜⁱ. As well, the form of the local learned parameter information transmitted from a given client node 102 to the server 110 may be different from the form of the local learned parameter information transmitted from another client node 102 to the server 110. Generally, the server 110 obtains the set of gradient vectors {gₜ¹, . . . , gₜ^{N}} in the current round of training, whether the gradient vectors are computed at the client nodes 102 or at the server 110.

In FIG. 4, example information generated in one round of training is indicated. For simplicity, the initial transmission of the previous-round global model wₜ₋₁, from the server 110 to the client nodes 102, is not illustrated. Further, the local learned parameter information 402(i) sent from each respective client node(i) 102 is shown in the form of a local learned parameter vector wₜⁱ. However, as discussed above, the client nodes 102 may transmit an update to the server 110 in other forms (e.g., as a gradient vector gₜⁱ).

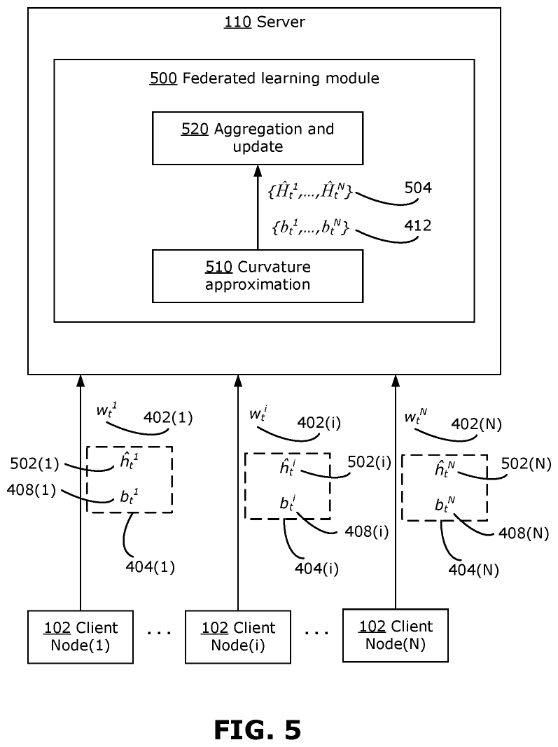

Each client node(i) 102 also sends local curvature information 404(i) to the server 110, denoted LCₜⁱ, thereby enabling the federated learning module 200 of the server 110 to approximate a local curvature of the objective function of the respective local model. In some embodiments, the local curvature information is generated by the client node 102 based on the local curvature of the local model 136, i.e. based on a second-order partial derivative of the objective function of the respective local model 136 with respect to one or more of the local learned parameters 137. Various examples of local curvature information are described below with reference to the example embodiments of FIGS. 5-10.

Thus, once the local model 136 has been trained using the local dataset 140, the client node 102 sends local learned parameter information to the server 110 by retrieving the stored values of the local learnable parameters 137 from the memory 138, generating the local curvature information 404 of an objective function of the local model 136, generating the local learned parameter information 402 based on the values of the local learnable parameters 137, and sending the local learned parameter information 402 and local curvature information 404 to the server 110.

After receiving the local learned parameter information 402 and local curvature information 404 from the client nodes 102, the server 110 processes the local learned parameter information 402 and local curvature information 404 obtained from each client node 102 to generate adjusted values of the global learnable parameters 127 of the global model 126. The server 110 then stores the adjusted values of the global learnable parameters 127 in the memory 128 as the learned global learnable parameters 127. These operations will now be described in greater terms with reference to the general example of FIG. 4, with additional details described below with reference to the example embodiments of FIGS. 5-10.

The example federated learning module 200 shown in FIG. 4 has two functional blocks: a curvature approximation block 210 and an aggregation and update block 220. However, although the federated learning module 200 is illustrated and described with respect to blocks 210, 220, it should be understood that this is only for the purpose of illustration and is not intended to be limiting. For example, the functions of the federated learning module 200 may not be split into blocks 210, 220, and may instead be implemented as a single function. Further, functions that are described as being performed by one of the blocks 210, 220 may instead be performed by the other of the blocks 210, 220.

The general approach to FL shown in FIG. 4 uses the curvature approximation block 210 to approximate the local curvatures of the objective functions of the local models 136 of the respective client nodes 102. The aggregation and update block 220 then operates to aggregates the local curvatures of the plurality of local models 136 and use this aggregated information to update the values of the global learnable parameters 127 of the global model 126.

The approximated local curvatures of the plurality of respective local models 136 are shown in FIG. 4 as a set 410 of Hessian matrices {Hₜ¹, . . . , Hₜ^{N}} and a set 412 of Hessian-vector products {bₜ¹, . . . , bₜ^{N}}, wherein each member of the set denoted by 1 through N corresponds to a respective client node(1) 102 through client node(N) 102. The details of generating these approximated local curvatures based on the local curvature information 404 and/or local learned parameter information 402 obtained from the client nodes 102 are described in detail with reference to FIGS. 5-10 below. For the present purposes, it will be understood that each Hessian matrix Hₜⁱ in the set 410 of Hessian matrices indicates an approximation of a second-order partial derivative of an objective function of the respective local model 136 with respect to one or more of the local learned parameters thereof, and each Hessian-vector product bₜⁱ in the set 412 of Hessian-vector products indicates the product of the respective Hessian matrix Hₜⁱ with a vector of learned parameter values, as described in further detail below. Unless otherwise indicated, the term “Hessian matrix” (or simply “Hessian”) as used herein refers to a square matrix of second-order partial derivatives of a scalar-valued function, or scalar field, in this case the objective function of a local model 136. It describes the local curvature of the objective function of many variables, in this case the entire set 137 of local learnable parameters of the local model 136.

The approximated local curvatures (e.g., the set 410 of Hessian matrices {Hₜ¹, . . . , Hₜ^{N}} and set 412 of Hessian-vector products {bₜⁱ, . . . , bₜ^{N}}) are received by the aggregation and update block 220 and used to update the values of the learned global learnable parameters 127. The goal of the aggregation and update block 220 is to find a good approximate solution for x* from the biased stationary points {x₁*, . . . , x_{N}*}, wherein x* indicates a stationary point of the global objective function (e.g. a local minimum or maximum, representing an optimal set of global learned parameter values or a target for convergence), and each xᵢ* indicates a stationary point of the local objective function of client node(i) 102 (representing a convergence point for a set of values of the local learnable parameters 137 when trained solely on the local dataset 140). This problem may be referred to herein as the “aggregation problem”.

To approximate a solution to the aggregation problem, Taylor series are used to compute the gradient of each local objective function ƒ₁, . . . , ƒ_{N} at point x*:

$$∇ {f}_{1} ( {x}^{*} ) = ∇ {f}_{1} ( {x}_{1}^{*} ) + {∇}^{2} {f}_{1} ( {x}_{1}^{*} ) ( {x}^{*} - {x}_{1}^{*} ) + o ( {‖ {x}^{*} - {x}_{1}^{*} ‖}_{2}^{2} ) , \\ ∇ {f}_{2} ( {x}^{*} ) = ∇ {f}_{2} ( {x}_{2}^{*} ) + {∇}^{2} {f}_{2} ( {x}_{2}^{*} ) ( {x}^{*} - {x}_{2}^{*} ) + o ( {‖ {x}^{*} - {x}_{2}^{*} ‖}_{2}^{2} ) , \\ ⋮ \\ ∇ {f}_{N} ( {x}^{*} ) = ∇ {f}_{N} ( {x}_{N}^{*} ) + {∇}^{2} {f}_{N} ( {x}_{N}^{*} ) ( {x}^{*} - {x}_{N}^{*} ) + o ( {‖ {x}^{*} - {x}_{N}^{*} ‖}_{2}^{2} ) . \qquad ( Equation 4 )$$

Adding the equations of (Equation 4), and setting

Σᵢ₌₁^{N}∇ƒᵢ(x*)=0

(because x* is the stationary point of Σᵢ₌₁^{N}ƒᵢ(x)) and

∇ƒ₁(x₁*)= . . . =∇_{N}(x_{N}*)=0

(because xᵢ* is the stationary point of ƒᵢ(x)), results in:

$$[ \frac{1}{N} {\sum }_{i}^{N} {∇}^{2} {f}_{i} ( {x}_{i}^{*} ) ] {x}^{*} = \frac{1}{N} {\sum }_{i}^{N} {∇}^{2} {f}_{i} ( {x}_{i}^{*} ) {x}_{i}^{*} + \frac{1}{N} {\sum }_{i}^{N} o ( {‖ {x}^{*} - {x}_{i}^{*} ‖}_{2}^{2} ) \qquad ( Equation 5 )$$

Ignoring the accuracy term Σᵢ₌₁^{N}o(∥x*−xᵢ*∥₂²) and using the notation

Hᵢ:=∇²ƒᵢ(xᵢ*) and bᵢ:∇²ƒᵢ=(xᵢ*)xᵢ*

results in the following system of linear equations:

$$[ {\sum }_{i} {H}_{i} ] {x}^{*} = {\sum }_{i} {b}_{i} \qquad ( Equation 6 )$$

This system of linear equations may be solved using the local curvature information to recover x*, which is the solution to the aggregation problem. The general form of this solution, using the Hessian matrices {Hₜ¹, . . . , Hₜ^{N}} 410 and Hessian-vector products {bₜ¹, . . . , bₜ^{N}} 412 received from the curvature approximation block 210, may be computed by the aggregation and update block 220 as:

$$[ {\sum }_{i} {H}_{i} ] {w}_{t} = {\sum }_{i} {b}_{i} \qquad ( Equation 7 )$$

This technique can thus be used to find an unbiased solution x* from the received biased solutions {x₁*, . . . , x_{N}*}, thereby solving the aggregation problem.

Once a solution is identified, the aggregation and update block 220 uses the solution wₜ=x* as the adjusted values of the global learnable parameters 127, which are then stored in memory 128 as the learned values of the global learnable parameters 127 of the current global model 126. The federated learning module 200 may make a determination of whether training of the global model should end. For example, the federated learning module 200 may determine that the global model 126 learned during the current round of training has converged. For example, the values wₜ of global learnable parameters 127 of the global model 126 learned in the current round of training may be compared to the values wₜ₋₁ of the global learnable parameters 126 of the global model 126 learned in the previous round of training (or the comparison may be made to an average of previous parameters, computed using a moving window), to determine if the two sets of values of the global learnable parameters 127 are substantially the same (e.g., within 1% difference). The training of the global model 126 may end when a predefined end condition is satisfied. An end condition may be whether the global model 126 has converged. For example, if the values wₜ of the global learnable parameters 127 of the global model 126 learned in the current round of training is sufficiently converged, then FL of the global model 126 may end. Alternatively or additionally, another end condition may be that FL of the global model 126 may end if a predefined computational budget and/or computational time has been reached (e.g., a predefined number of training rounds has been carried out).

It will be appreciated that ignoring the accuracy term Σᵢ₌₁^{N}o(∥x*−xᵢ*∥₂²) in constructing (Equation 6) may introduce some error. The value of the error depends on the distance between x* and xᵢ*−the closer the distance, the smaller the error. However, in practice, these distances cannot be controlled, and the resulting error may mean that w* is not an optimal solution. To achieve a more desirable solution for the values wₜ of the global learnable parameters 127, the FL module 200 operations described above may be iterated over multiple rounds of federated learning and communication between the server 110 and client nodes 102 until the machine learning algorithm results in convergence of the global model 126, as described above.

In practice, the proposed solution to the aggregation problem described above cannot feasibly be computed directly using complete curvature information computed at the client node 102 and sent to the server 110. Models whose values of their parameters are learned using machine learning (“machine learning models”) can easily have millions of learnable parameters, and due to the quadratic relationship between the size of the Hessian matrices and the number of learnable parameters in the model, the cost of computing the Hessian matrices {H₁, . . . , H_{N}} at the client nodes 102 and transferring them over communication channels is prohibitive. Furthered, the system of linear equations in (Equation 6) might not have an exact solution. To address the latter issue, the federated learning module 200 of the server 110 may be configured to solve the following quadratic form of the aggregation problem instead of (Equation 6):

$${x}^{*} = {arg min}_{x ∈ {ℝ}^{p}} {‖ {\sum }_{i} {α}_{i} {H}_{i} x - {\sum }_{i} {α}_{i} {b}_{i} ‖}_{2}^{2} \qquad ( Equation 8 )$$

wherein coefficient αᵢ (0≤αᵢ≤1) represents a weight hyperparameter associated with the local model 136 of client node(i) 102. The set of coefficients {αₜ¹, . . . , αₜ^{N}} an may be provided as hyperparameters of the global model 126 during the initialization phase. These coefficients {αₜ¹, . . . , αₜ^{N}} an may be configured to weight the contributions of different local models 136 of respective client nodes 102 differently depending on factors such as the size of the respective local datasets 140 or other design considerations.

It will be appreciated that, whereas (Equation 8) uses the second norm (norm-2) to measure the discrepancy between the two terms Σᵢ αᵢĤᵢx and Σᵢ αᵢbᵢ, some embodiments may use other norms, such as norm-1 or even norm-∞, to measure and thereby minimize this discrepancy. This also holds for (Equation 9), (Equation 10), and (Equation 11) below.

One advantage of the formulation in (Equation 8) is that {H₁, . . . , H_{N}} is not necessarily required for solving the aggregation problem. For example, the aggregation and update block 220 can solve (Equation 8) by only having access to Hᵢ times w in each step of the optimization process, as described in J. Martens, “Deep learning via Hessian-free optimization,” in ICML, 2010. It will be appreciated that many different techniques may be used to solve (Equation 8) without generating Hessian matrices, such as iterative application of the conjugate gradient method. By relying only on the Hessian-vector product Hᵢ times w, instead of the full Hessian matrix Hᵢ, may also reduce communication costs. Variants of this approach are described below with reference to the example embodiments of FIGS. 5-10.

FIG. 5 is a block diagram illustrating information flows of a first example embodiment 500 of the general federated learning module 200 of FIG. 4. The first example federated learning module 500 uses local curvature information 404 that includes diagonal Hessian matrix elements 502 ĥ. Instead of computing a full Hessian matrix Hᵢ at the client node 102 and sending the full Hessian matrix to the server, client node(i) 102 only needs to compute the diagonal elements of Hessian matrix Hᵢ, and send a vector of those diagonal elements ĥᵢ 502 (i) to the server 110 as part of the local curvature information 404(i). The diagonal elements ĥᵢ 502 (i) can be used by the curvature approximation block 510 to construct matrix [symbol] , which has the same size as Hᵢ, and is formed by setting its diagonal elements equal to ĥᵢ and its off-diagonal elements to zero. The set 504 of constructed matrices {Ĥ_{T}¹, . . . , Ĥₜ^{N}} are then received by the aggregation and update block 520.

The client node 102 also computes the Hessian-vector product bᵢ=Hᵢwᵢ* and includes this vector bᵢ 408(i) in the local curvature information 404 sent to the server 110. As described above, the Hessian-vector product Hᵢwᵢ* can be computed without generating the full Hessian matrix using any of a number of known methods. The curvature approximation block 510 generates a set 412 of first Hessian-vector products {bₜ¹, . . . , bₜ^{N}}, which are received by the aggregation and update block 520, as in the example of FIG. 4.

In some embodiments, the Hessian-vector product bᵢ may not be generated by the client node 102 and sent to the server 110. Instead, the client node 102 may simply send the local parameter vector wⁱₜ to the server 110, and the server 110 may estimate Hessian-vector product bᵢ by multiplying wᵢ and an estimated Hessian matrix Hᵢ generated by the curvature approximation block 210.

The client node 102 also generates local learned parameter information 402, shown in FIG. 5 as learned parameter vector wⁱₜ, and sends the local learned parameter information 402, as in the example of FIG. 4.

The aggregation and update block 520 of the first example federated learning module 500 uses the information received from the curvature approximation block 510—namely, the set 412 of first Hessian-vector products {bₜ¹, . . . , bₜ^{N}} and the set 504 of constructed matrices {Ĥₜ¹, . . . , Hₜ^{N}}—to solve the following optimization problem for wₜ:

$${w}_{t} = {arg min}_{x ∈ {ℝ}^{p}} {‖ {\sum }_{i} {α}_{i} {H}^{i} x - {\sum }_{i} {α}_{i} {b}^{i} ‖}_{2}^{2} \qquad ( Equation 9 )$$

By approximating each local model's Hessian matrix H using only its diagonal elements h, the computational cost and/or memory footprint at each client node 102 and/or the server 110 may be reduced, and the size of the information sent to the server 110 from each client node 102 is reduced from O(n²) to O(n) wherein n is the number of learned parameters of the model (i.e., the global model 126 and the local models 136 each have the same values for n learnable parameters). This reduction in costs from a quadratic to a linear function of the number of learnable parameters is quite significant considering that machine learning models can easily have millions of learned parameters.

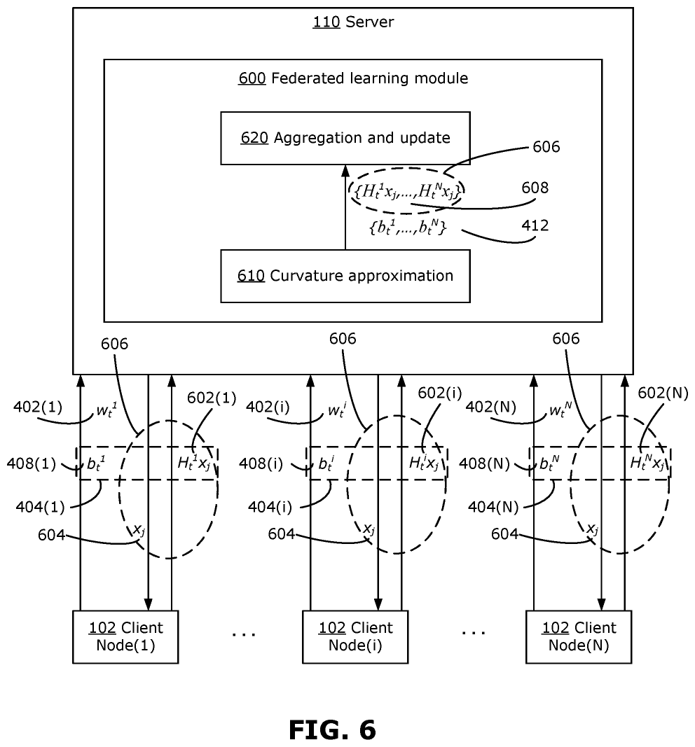

FIG. 6 is a block diagram illustrating information flows of a second example embodiment 600 of the general federated learning module 200 of FIG. 4. The second example federated learning module 600 uses multiple rounds of bidirectional communication of parameter vectors and Hessian-vector products between the client nodes and the server to approximate local curvatures.

As described above, the server 110 does not need to have a set of full Hessian matrices {H₁, . . . , H_{N}} for the local models 136 in order to solve (Equation 8). Iterative algorithms known in the art, such the conjugate gradient method, can be used to solve problems such as (Equation 8) using only Hessian-vector products Hxⱼ wherein xⱼ is the solution to the aggregation problem (or the current state of the global learned parameters following the execution of an aggregation operation) at iteration j of the aggregation operation, as described in greater detail below.

In the second example federated learning module 600, in contrast to the systems 400, 500 described above with reference to FIGS. 4 and 5, a single round of training involved multiple consecutive, bidirectional communications between the server 110 and each client node 102. A round of training may begin, as described above with reference to the general case, with the global model information being generated at the server 110 and sent to each client node 102. The client node may then generate the local parameter information 402(i) (shown in FIG. 6 as local learned parameter vector wₜⁱ) and send it to the server 110 along with local curvature information 404(i) comprising the first Hessian-vector product be 408(i), similar to the example of FIG. 5.

The second example federated learning module 600 then performs an aggregation operation, consisting of several steps. First, the following value is minimized by the aggregation and update block 620:

$${‖ {\sum }_{i} {α}_{i} {H}^{i} {x}_{j} - {\sum }_{i} {α}_{i} {b}^{i} ‖}_{2}^{2} . \qquad ( Equation 10 )$$

Second, the values wₜ of the global learnable parameters 127 are adjusted by the aggregation and update block 620 such that wₜ=xⱼ. This adjustment may be made to a temporary set of values or the values stored in the memory 128 as the stored values of the global learnable parameters 127. Third, the server 110 sends the current state of optimization, i.e. the values xⱼ of the global learnable parameter 127, to the client nodes 102. The values xⱼ of the global learnable parameters 127 may be sent, e.g., as a parameter vector xⱼ 604 comprising the values of the global learnable parameters 127. Fourth, the server 110 obtains a second Hessian-vector product 602 Hₜⁱxⱼ, based on the Hessian matrix of the respective local model Hₜⁱ and the parameter vector x₁ from each client node 102, and the curvature approximation block 610 generates a set 608 of second Hessian-vector products based on the second Hessian-vector product 602 Hₜⁱxⱼ obtained from each client node 102. The aggregation operation then begins a new iteration: the aggregation and update block 620 performs the first step to compute xⱼ₊₁ by using the information obtained from the client nodes 102. The steps of the aggregation operation may be iterated until a convergence condition is satisfied, thereby ending the round of training. The convergence condition may be defined based on the values or gradients of the global learned parameters, based on a performance metric, or based on a maximum threshold for iterations, time, communication cost, or some other resource being reached. In some embodiments, changes in the value of (Equation 10) are monitored by the aggregation and update block 620; if the changes in two consecutive iterations (or over several consecutive iterations) of the aggregation operation are below a threshold, the current round of training is terminated.

In FIG. 6, most of the operations and communications shown are performed once per training round. However, those operations and communications enclosed within ellipses 606—namely, the communication of the parameter vector xⱼ 604 from the server 110, the communication of the second Hessian-vector product 602 Hₜⁱxⱼ to the server 110, and the generation of the set 608 of second Hessian-vector products {Hₜ¹, . . . , Hₜ^{N}} by the curvature approximation block 610 based on the second Hessian-vector product 602 Hₜⁱxⱼ obtained from each client node 102—are performed during each iteration of the aggregation operation during a round of training. The local curvature information 404 is identified in FIG. 6 as comprising the first Hessian-vector product bₜⁱ 408(i), sent to the server 110 once per training round, and also the second Hessian-vector product 602 Hₜⁱxⱼ sent to the server 110 once per iteration of the aggregation operation within a training round.

One potential advantage realized by the second example FL module 600 is that it may find the exact solution of (Equation 8) without the need to collect the full Hessian matrices {H₁, . . . , H_{N}} from the client nodes 102. However, it may require more communication between the server 110 and client nodes 102 in each training round than other embodiments described herein, even if the communication costs are still on the order of n instead of n².

It will be appreciated that the operation of the curvature approximation block 610 in the second example FL module 600 may be limited to the concatenation or formatting of the received local curvature information 404 into the set 412 of first Hessian-vector products {bₜ¹, . . . , bₜ^{N}} and set 608 of second Hessian-vector products {Hₜ¹, . . . , Hₜ^{N}}. Accordingly, in some embodiments the operations of the curvature approximation block 610 may be performed by the aggregation and update block 620.

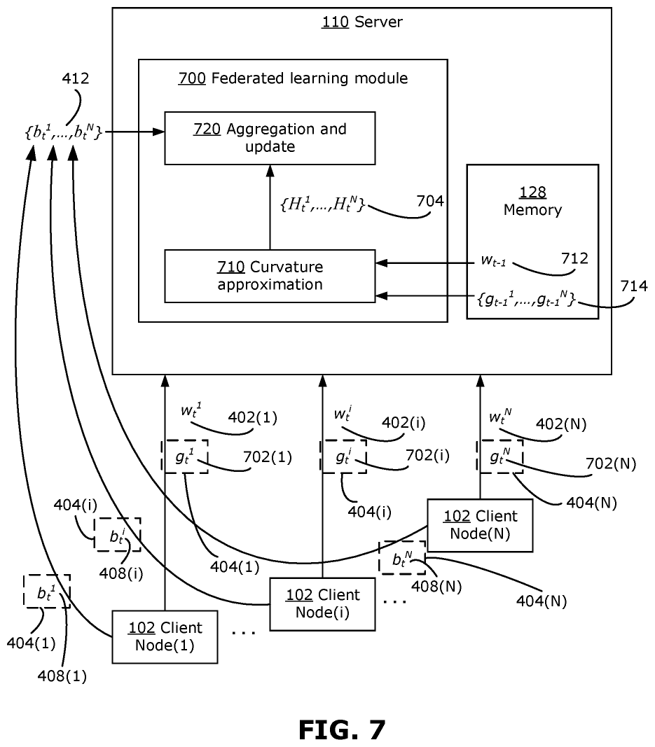

FIG. 7 is a block diagram illustrating information flows of a third example embodiment 700 of the general federated learning module 200 of FIG. 4. The third example federated learning module 700 uses curvature information 404 including gradient vectors 702 based on the local learned parameters, and it relies on the storage into and retrieval from server memory 128 various previous values of the gradient vectors 702 and global learned parameters 127.

The third example federated learning module 700 may begin a round of training, as described above with reference to the general case, with the global model information being generated at the server 110 and sent to each client node 102. The client node may then generate the local parameter information 402(i) (shown in FIG. 6 as local learned parameter vector wₜ) and send it to the server 110 along with local curvature information 404(i) comprising the first Hessian-vector product bₜⁱ 408(i), similar to the example of FIG. 5. However, in this third example federated learning module 700, the first Hessian-vector product bₜⁱ 408(i) sent from each client node 102 is not used by the curvature approximation block 710 to estimate local curvature; instead, the first Hessian-vector products bₜⁱ 408(i) obtained from each client node 102 are assembled into a set 412 of Hessian-vector products {bₜ¹, . . . , bₜ^{N}}, which are used by the aggregation and update block 720 as described below.

The local curvature information 404(i) also comprises a gradient vector gₜⁱ 702(i) comprising a plurality of gradients of the objective function of the local model 136 of the respective client node 102, sent to the server 110 during each training round.

The curvature approximation block 710 uses a Quasi-Newton method to generate an estimated curvature of the objective function of each local model 136 based on the local learned parameter information 404(i) and the gradient vector 702(i) obtained from the respective client node 102, as well as the stored global learned parameters 127 of the global model and the stored gradient vector of the respective local model 136 from the previous training round (i.e. previous global learned parameters wₜ₋₁ 712 and previous gradient vector stored as part of a stored set 714 of previous gradient vectors {gₜ₋₁¹, . . . , gₜ₋₁^{N}}, all of which are stored in the memory 128).

In some examples, the set 714 of previous gradient vectors {gₜ₋₁¹, . . . , gₜ₋₁^{N}} may not be available or may not be complete, either because this training round is the first training round in which one or more of the client nodes 102 is participating, or because one or more of the client nodes did not participate in the immediately prior round of training. In such cases, the client nodes 102 that did not participate in an immediately prior training round (and so do not have a previous gradient vector stored on the server 110) may be configured to send a first gradient vector g₁₋₁ⁱ before updating the local learned parameters 137, and then send a second gradient vector gₜⁱ after updating the local learned parameters 137 during the current training round.

Quasi-Newton methods belong to a group of optimization algorithms that use the local curvature information of functions (in this case, the local objective functions) to find the local stationary points of said functions. Quasi-Newton methods do not require the Hessian matrix to be computed exactly. Instead, quasi-Newton methods estimate or approximate the Hessian matrix by analyzing successive gradient vectors (such as the set 702 of the current gradient vectors {gₜ¹, . . . , gₜ^{N}} obtained from the client nodes 102 and the set 714 of previous gradient vectors {gₜ₋₁¹, . . . , gₜ₋₁^{N}} retrieved from memory 128). It will be appreciated that there are several types of quasi-Newton methods that use different techniques to approximate the Hessian matrix.

Thus, a quasi-Newton method is used to generate an estimated curvature of the objective function of each local model 136 in the form of an estimated Hessian matrix Hₜ¹, and the estimated Hessian matrices are received by the aggregation and update block 720 as a set 704 of estimated Hessian matrices {Hₜ¹, . . . , Hₜ^{N}}.

The aggregation and update block 720 receives the set 704 of estimated Hessian matrices {Hₜ¹, . . . , Hₜ^{N}} from the curvature approximation block 710 and obtains the set 412 of Hessian-vector products {bₜ¹, . . . , bₜ^{N}} from the client nodes 102. The aggregation and update block 720 uses these inputs to solve the following quadratic optimization problem to identify solution wₜ:

$${w}_{t} = {arg min}_{x ∈ {ℝ}^{p}} {‖ {\sum }_{i} {α}_{i} {H}^{i} x - {\sum }_{i} {α}_{i} {b}^{i} ‖}_{2}^{2} \qquad ( Equation 11 )$$

Before the values of the global learnable parameters 127 are adjusted to wₜ, the previous values wₜ₋₁ of the global learned parameters 127 are stored in the memory 128 along with the set 702 of gradient vectors {gₜ¹, . . . , gₜ^{N}} received in the current training round. The stored values wₜ of the global learnable parameters 127 and the stored set 702 of the gradient vectors {gₜ¹, . . . , gₜ^{N}} are then ready for use by the next round of training (t→t+1) as the stored previous global learnable parameters 127 and stored set 714 of previous gradient vectors.

One advantage potentially realized by the third example FL module 700 is that only the gradient vectors 702 are required to construct the set 704 of estimated Hessian matrices {Hₜ¹, . . . , Hₜ^{N}} and solve (Equation 8).

The operations of the various example FL modules 400, 500, 600, 700 described above can be performed as a method by the server 110. The operations performed by the client nodes 102 of the system 100, also described above, may also form part of a common method with the operations of the example FL modules 400, 500, 600, 700. Examples of such methods will now be described with reference to the system 100 and the example FL modules 400, 500, 600, 700.

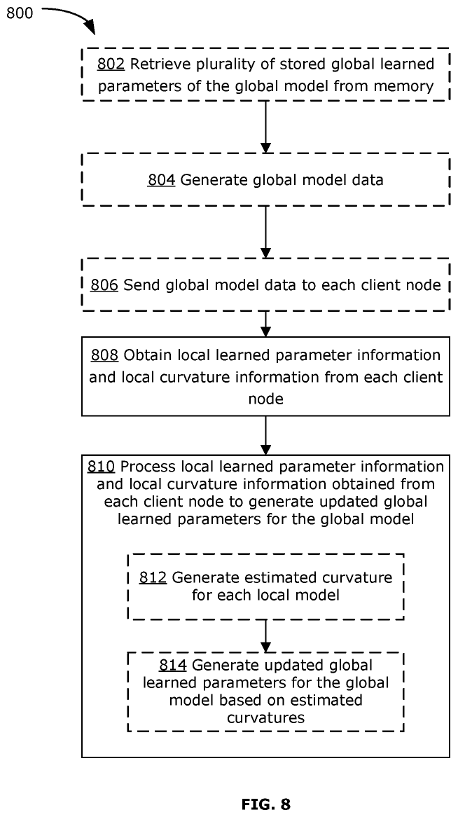

FIG. 8 is a flowchart illustrating a first example method 800 for using federated learning to train a global model for a particular task. Method 800 may be implemented by the server 110 (e.g., using the general federated learning module 200 or one of the specific example federated learning modules 500, 600, or 700 described above), but some steps may make reference to information received from the client nodes 102 of the system 100 and make assumptions about the content or format of such information for the sake of clarity. The system 100 in which the method 800 is performed thus comprises a plurality of local models 136 stored at a plurality of respective client nodes 102. The global model 126 and each local model 136 are trained to perform the same task. Each local model 136 has local learnable parameters 137 whose values are learned using a machine learning algorithm and a respective local dataset 140 of the respective client node 102.

Whereas method 800 is a general method generally corresponding to the operations of the general FL module 200, second example method 900 and third example method 1000 are more specific embodiments corresponding to the operations of more specific example FL modules, e.g. the second example FL module 600 and third example FL module 700 respectively. The method 800 may be used to perform part or all of a single round of training, for example. The method 800 may be used during the training phase, after the initialization phase has been completed.

Prior to beginning method 800, a plurality of client nodes 102 may be selected to participate in the current round of training. The client nodes 102 may be selected at random from the total client nodes 102 available. The client nodes 102 may be selected such that a certain predefined number (e.g., 1000 client nodes) or certain predefined fraction (e.g., 10% of all client nodes) of client nodes 102 participate in the current round of training. Selection of client nodes 102 may be based on predefined criteria, such as selecting only client nodes 102 that did not participate in an immediately previous round of training, etc.

In some example embodiments, selection of client nodes 102 may be performed by another entity other than the server 110 (e.g., the client nodes 102 may be self-selecting, or may be selected by a scheduler at another network node). In some example embodiments, selection of client node 102 may not be performed at all (or in other words, all client nodes are selected client nodes), and all client nodes 102 that participate in training the global model 126 also participate in every round of training.

The method 800 optionally begins with steps 802, 804 and 806, which concern the retrieval, generation and transmission of information about the previous global model 126 (e.g., the stored values wₜ₋₁ of global learnable parameters 127 of the global model 126 that are adjusted in the previous training round). Optional steps are outlined in dashed lines in the figures. At 802, the stored global learned parameters (i.e. the stored values wₜ₋₁ of global learnable parameters 127) of the global model 126 are retrieved from memory 128 by the server 110. At 804, global model information comprising the stored global learned parameters is generated by the server 110, e.g. by the FL module 200. At 806, the global model information is transmitted or otherwise sent to each client node 102.

As described above, the stored global learned parameters of the previous global model 127 may be the result of a previous round of training. In the special case of the first round of training (i.e., immediately following the initialization phase), it may not be necessary for the server 110 to perform steps 802, 804, or 806, because the global learnable parameters 127 at the server 110 and the local learnable parameters 137 at all client nodes 102 should have the same initial values after initialization.

After step 806, the method 800 then proceeds to step 808. The server 110 obtains local learned parameter information 402 and local curvature information 404 from each client node 102. The local learned parameter information 402 relates to the local learned parameters 137 of the respective local model 136. As described above in reference to FIG. 4, the local learned parameter information 402 may include, e.g., the values of the local learnable parameters 137 themselves or the gradients of the local learnable parameters 137. The local curvature information 404 is local curvature information of an objective function of the respective local model 136, as described above in reference to the various embodiments of FIGS. 4-7, and may include, e.g., a first Hessian-vector product bₜⁱ 408 and set 502 of diagonal elements ĥ of the Hessian matrix of the respective local model.

The method then proceeds to step 810, which optionally includes sub-steps 812 and 814. At 810, the server 110 (e.g. using the FL module 200) processes the local learned parameter information 402 and local curvature information 404 obtained from each client node 102 to generate the adjusted global learned parameters for the global model 126. At optional sub-step 812, for each local model 136, an estimated curvature of the objective function of the respective local model 136 is generated based on the local learned parameter information 402 and local curvature information 404 of the respective local model 136. Sub-step 812 may be performed by a curvature approximation block 210 (or 510, 610, or 710), and the estimated curvature generated thereby may include, e.g., a set 410 of Hessian matrices {Hₜ¹, . . . , Hₜ^{N}} and a set 412 of first Hessian-vector products {bₜ¹, . . . , bₜ^{N}}. As described above, each first Hessian-vector product bₜⁱ is based on the local learned parameters 137 of the respective local model 136 and a Hessian matrix, and the Hessian matrix comprises second-order partial derivatives of the objective function of the respective local model 136 with respect to the local learned parameters 137.

In other embodiments, the estimated curvature may include other information generated by the curvature approximation block (e.g. 510, 610, or 710) of the respective example embodiment, such as a set 504 of constructed matrices {Ĥₜ¹, . . . , Ĥₜ^{N}}, a set 608 of second Hessian-vector products {Hₜ¹, . . . , Hₜ^{N}}, or a set 704 of estimated Hessian matrices {Hₜ¹, . . . , Hₜ^{N}}.

At optional sub-step 814, adjusted values of the global learnable parameters 127 of the global model 126 are generated based on the estimated curvatures generated at sub-step 812. This step 814 corresponds to the operations of the aggregation and update block 220 (or 520, 620, or 720), as described above with reference to FIGS. 4-7. In some embodiments, the adjusted values of the global learnable parameters 127 are generated by performing quadratic optimization based at least in part on the estimated curvature and the first Hessian-vector product of each local model 136 (e.g. set 412 of first Hessian-vector products {bₜ¹, . . . , bₜ^{N}}). In some embodiments, such as embodiments corresponding to the operations of the first example FL module 500, performing the quadratic optimization comprises solving the equation w= [symbol] ∥ΣᵢαᵢĤᵢx−Σᵢαᵢbᵢ∥₂², wherein w is the adjusted values of the global learnable parameters 127, i is an index value corresponding to a client node of the plurality of client nodes, αᵢ is a weight assigned to the client node having index value I, Ĥᵢ is a matrix representing the estimated curvature based on the diagonal elements of the Hessian matrix of the client node having index value I, and bᵢ is the first Hessian-vector product obtained from the client node having index value i.

The other operations performed by the server 110 during a round of training, such as storing the adjusted values of the global learnable parameters 127 in memory 128, may be included in the method 800 in some embodiments. In other embodiments they may be performed outside of the scope of the method 800, or may be subsumed into the existing method steps described above.

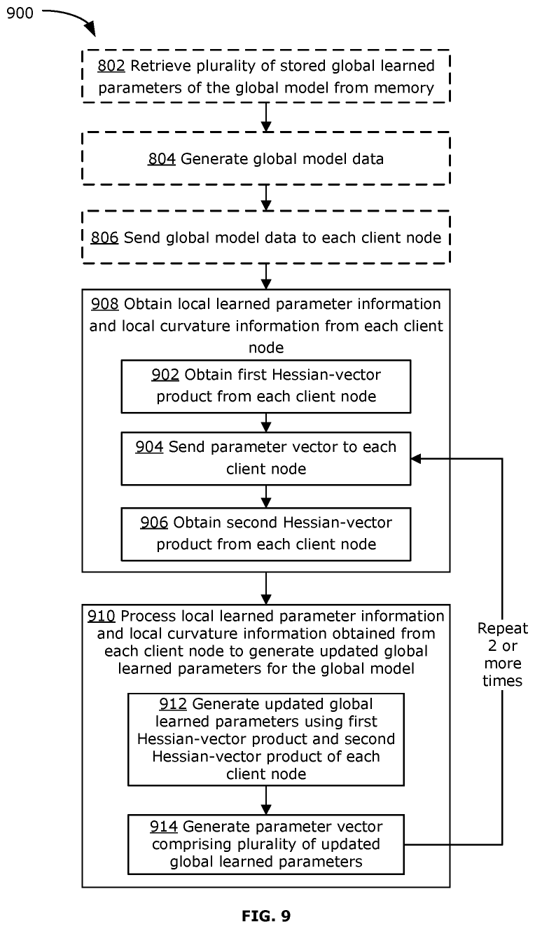

FIG. 9 is a flowchart illustrating a second example method 900 for using federated learning to train a global model for a particular task. Method 900 generally corresponds to the operations of the second example FL module 600, using multiple rounds of bidirectional communication of parameter vectors and Hessian-vector products between the client nodes 102 and the server 110.

Method 900 may be understood to correspond to the details of method 800 described above unless otherwise specified. Like method 800, method 900 optionally begins with steps 802, 804 and 806 as described above with reference to FIG. 8. Method 900 then proceeds to step 908.

At 908, as at step 808 described above, the server 110 obtains local learned parameter information 402 and local curvature information 404 from each client node 102. However, step 908 is broken down into three sub-steps 902, 904, and 906.

At 902, the server 110 obtains a first Hessian-vector product (such as first Hessian-vector product bₜⁱ 408) from each client node 102. At 904, the server 110 sends a parameter vector (such as parameter vector xⱼ 604) to each client node 102. At 906, the server 110 obtains, from each client node 102, a second Hessian-vector product (such as second Hessian-vector product Hₜⁱxⱼ 602) based on the Hessian matrix of the respective local model Hₜⁱ and the parameter vector xⱼ 604 (e.g., by multiplying them). The method 900 then proceeds to step 910.

At 910, as at step 810 of method 800, the server 110 (e.g. using the second example FL module 600) processes the local learned parameter information 402 and local curvature information 404 obtained from each client node 102 to generate adjusted values for adjusted the global learned parameters 127 of the global model 126. Step 910 includes sub-steps 912 and 914.

At 912, in response to obtaining the second Hessian-vector product (such as second Hessian-vector product Hₜⁱxⱼ 602) from each client node, the server 110 uses the aggregation and update block 620 to generate adjusted values of the global learnable parameters 127 using the first Hessian-vector product (such as first Hessian-vector product bₜⁱ 408) and second Hessian-vector product (e.g., Hₜⁱxⱼ) of each client node 102. In some embodiments, step 912 may be performed by performing quadratic optimization, as described above with reference to FIG. 6. In particular, performing the quadratic optimization comprises solving the minimization problem minimize ∥ΣᵢαᵢHᵢx−Σᵢαᵢbᵢ∥₂² wherein x is the adjusted values of the adjusted global learnable parameters 127, i is an index value corresponding to a client node of the plurality of client nodes, αᵢ is a weight assigned to the client node having index value I, Hᵢx is the second Hessian-vector product obtained from the client node having index value I, and bᵢ is the first Hessian-vector product obtained from the client node having index value i.

At 914, the server 110 uses the aggregation and update block 620 to generate the parameter vector x₁ 604 such that the parameter vector comprises the adjusted values of the global learnable parameters 127.

After sub-step 914, the method 900 may return to step 904 one or more times, such that the sequence of steps 904, 906, 912, 914 is repeated two or more times. This repetition corresponds to iteration of the aggregation operation described above with reference to FIG. 6.

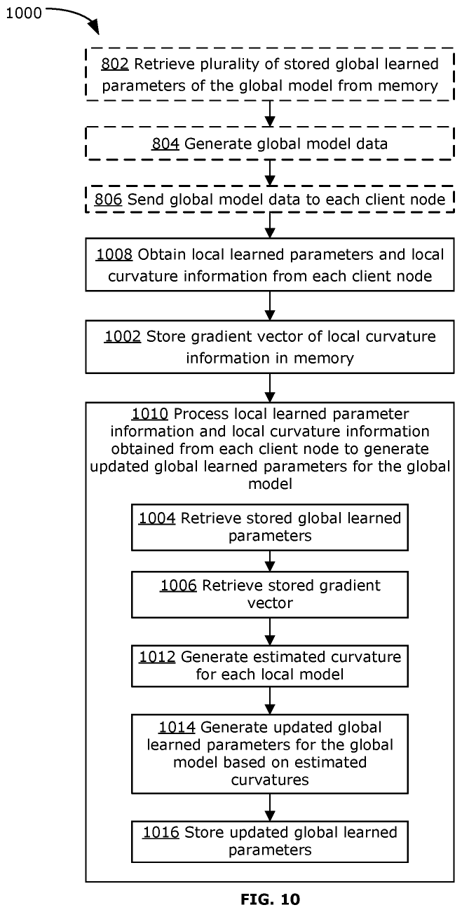

FIG. 10 is a flowchart illustrating a third example method 1000 for using federated learning to train a global model for a particular task. Method 1000 generally corresponds to the operations of the third example FL module 700, using curvature information including gradient vectors.

Method 1000 may be understood to correspond to the details of method 800 described above unless otherwise specified. Like method 800, method 900 optionally begins with steps 802, 804 and 806 as described above with reference to FIG. 8. Method 900 then proceeds to step 1008.

At 1008, as at step 808 described above, the server 110 obtains local learned parameter information 402 and local curvature information 404 from each client node 102. However, at 1008, the local curvature information 404 obtained from each client node 102, in addition to including the first Hessian-vector product bₜⁱ 408, further comprises a gradient vector gₜⁱ 702 comprising a plurality of gradients of the objective function of the local model 136 of the respective client node 102. The method 1000 then proceeds to step 1002.

At 1002, the server 110 stores the gradient vectors gₜⁱ 702 obtained from each respective client node 102 in the memory 128 as a stored gradient vector of the respective client node 102. These stored gradient vectors may be retrieved in the next training round as the stored set 714 of previous gradient vectors {gₜ₋₁¹, . . . , gₜ₋₁^{N}}. The method 1000 then proceeds to step 1010.

At 1010, as at step 810 described above, the server 110 (e.g. using the third example FL module 700) processes the local learned parameter information 402 and local curvature information 404 obtained from each client node 102 to generate adjusted values of the global learnable parameters 127 of the global model 126. Step 1010 includes sub-steps 1004, 1006, 1012, 1014, and 1016.

At 1004, the server 110 retrieves from memory 128 the learned values of the global learnable parameters 127 of the global model 126. At 1006, for each local model 136, the server 110 retrieves from memory 128 a stored gradient vector of the respective local model 136 (e.g. a gradient vector gₜ₋₁ⁱ stored as part of stored set 714 of previous gradient vectors {gₜ₋₁¹, . . . , gₜ₋₁^{N}}).

At 1012, for each local model 136, the curvature approximation block 710 generates an estimated curvature of the objective function of the respective local model 136. The estimated curvature is generated based on the local learned parameter information 402 of the respective local model 136, the gradient vector 702 obtained from the respective client node 102, the previous values wₜ₋₁ of the global learnable parameters 127 of the global model 126, and the stored gradient vector gₜ₋₁ⁱ of the respective local model 136. The generation of the estimated curvature may be performed using a quasi-Newton method, as described above with reference to FIG. 7. The curvature approximation block 710 may apply a quasi-Newton method to generate an estimated Hessian matrix Hₜⁱ of the local model 136 of the client node 102 based on the gradient vector gₜⁱ 702 obtained from the client node 102, the stored global learned parameters wₜ₋₁ 127, and the stored gradient vector gₜ₋₁ⁱ for the client node.

At 1014, the aggregation and update block 720 performs quadratic optimization to generate adjusted values of the global learnable parameters 127 of the global model based at least in part on the estimated curvatures of the objective function of the respective local model 136. The adjusted values of global learnable parameters 127 may also be generated based on additional information, such as the first Hessian-vector product bₜⁱ 408 obtained from each of the plurality of client nodes 102 (i.e., the set 412 of first Hessian-vector products {bₜ¹, . . . , bₜ^{N}}).

In some embodiments, performing the quadratic optimization comprises solving the equation w= [symbol] ∥ΣᵢαᵢHᵢx−Σᵢαᵢbᵢ∥₂² wherein w is the adjusted values of the global learnable parameters 127, i is an index value corresponding to a client node of the plurality of client nodes, αᵢ is a weight assigned to the client node 102(i) having index value i, Hᵢ is a matrix representing the estimated curvature of the objective function of the local model of the client node having index value I, and bᵢ is the first Hessian-vector product obtained from the client node having index value i.

At 1016, the server 110 stores the adjusted values of the global learnable parameters 127 in the memory 128 as the learned values of the global learnable parameters 127.

The examples described herein may be implemented in a server 110, using FL to learn values of the global learnable parameters 127 of a global model. Although referred to as a global model, it should be understood that the global model at the server 110 is only global in the sense that the values of its learnable parameters 127 have been optimized to perform accurate prediction with respect to the local data in the local datasets 140 across all the client nodes 102 involved in the learning the global model. The global model may also be referred to as a general model. A trained global model may continue to be adjusted using FL, as new local data is collected at the client nodes 102. In some examples, a global model trained at the server 110 may be passed up to a higher hierarchical level (e.g., to a core server), for example in hierarchical FL.

The examples described herein may be implemented using existing FL system. It may not be necessary to modify the operation of the client nodes 102, and the client nodes 102 need not be aware of how FL is implemented at the server 110. Different client nodes 102 may generate the various types of information sent to the server 110 differently from one another.

The examples described herein may be adapted for use in different applications. In particular, the disclosed examples may enable FL to be practically applied to real-life problems and situations.

For example, because FL enables learning of values of the learnable parameters of global model for a particular task without violating the privacy of the client nodes, the present disclosure may be used for learning the values of the learnable parameters of a global model for a particular task using data collected at end users' devices, such as smartphones. FL may be used to learn a model for predictive text entry, for image recommendation, or for implementing personal voice assistants (e.g., learning a conversational model), for example.

The disclosed examples may also enable FL to be used in the context of communication networks. For example, end users browsing the internet or using different online applications generate a large amount of data. Such data may be important for network operators for different reasons, such as network monitoring, and traffic shaping. FL may be used to learn a model for performing traffic classification using such data, without violating a user's privacy. In a wireless network, different base stations can perform local training of the model, using, as their local dataset, data collected from wireless user equipment.

Other applications of the present disclosure include application in the context of autonomous driving (e.g., autonomous vehicles may provide data to learn an up-to-date model of traffic, construction, or pedestrian behavior, to promote safe driving), or in the context of a network of sensors (e.g., individual sensors may perform local training of the model, to avoid sending large amounts of data back to the central node).

In various examples, the present disclosure describes methods, apparatuses and systems to enable real-world deployment of FL. The goals of low communication cost and mitigating local bias, which are desirable for practical use of FL, may be achieved by the disclosed examples.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration information, or other data, which, when executed, cause a machine (e.g., a processor or other processing device) to perform steps in a method according to examples of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure. In particular, operations described in the context of one of the example federal learning modules 400, 500, 600, or 700 may be combined with operations described in the context of one or more of the other example federal learning modules 400, 500, 600, or 700 to achieve hybrid functionality, redundancy, additional robustness, or recombination of operations from the various example embodiments.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A method for training a global model using federated learning in a system comprising a plurality of local models stored at a plurality of respective client nodes, the global model and each local model being trained to perform the same task, each local model having a plurality of local learnable parameters with values based on a respective local dataset of the respective client node, the method comprising:
obtaining, from each client node:
local learned parameter information relating to the plurality of local learnable parameters of the respective local model; and
local curvature information of an objective function of the respective local model; and
processing the local learned parameter information and local curvature information obtained from each client node to generate a plurality of adjusted global learned parameters for the global model.

2. The method of claim 1, wherein the local curvature information obtained from a respective client node comprises a first Hessian-vector product based on the plurality of local learned parameters of the respective local model and a Hessian matrix, the Hessian matrix comprising second-order partial derivatives of the objective function of the respective local model with respect to the plurality of local learnable parameters.

3. The method of claim 2, wherein the local curvature information received from each client node further comprises a set of diagonal elements of the Hessian matrix of the respective local model.

4. The method of claim 3, wherein processing the local learned parameter information and local curvature information obtained from each client node comprises:
for each local model, generating an estimated curvature of the objective function of the respective local model based on the local learned parameter information of the respective local model and the set of diagonal elements of the Hessian matrix of the respective local model; and
generating the plurality of adjusted global learned parameters for the global model based on the estimated curvatures of the objective functions of each of the plurality of local models.

5. The method of claim 4, wherein the plurality of adjusted global learned parameters are generated by performing quadratic optimization based on the estimated curvature and first Hessian-vector product of each local model.

6. The method of claim 5, wherein performing the quadratic optimization comprises solving the equation:
$$w = {arg min}_{x ∈ {ℝ}^{p}} {‖ {\sum }_{i} {α}_{i} {\hat{H}}_{i} x - {\sum }_{i} {α}_{i} {b}_{i} ‖}_{2}^{2}$$
wherein:
w is the plurality of adjusted global learned parameters;
i is an index value corresponding to a client node of the plurality of client nodes;
αᵢ is a weight assigned to the client node having index value i;
Ĥᵢ is a matrix representing the estimated curvature based on the diagonal elements of the Hessian matrix of the client node having index value i; and
bᵢ is the first Hessian-vector product obtained from the client node having index value i.

7. The method of claim 2, wherein:
obtaining the local curvature information from each client node comprises:
obtaining, from the respective client node, the first Hessian-vector product; and
repeating two or more times:
sending, to the respective client node, a parameter vector comprising a plurality of global learned parameters of the global model; and
obtaining, from the respective client node, a second Hessian-vector product based on the Hessian matrix of the respective local model and the parameter vector.

8. The method of claim 7, wherein generating the plurality of adjusted global learned parameters comprises repeating two or more times:
in response to obtaining the second Hessian-vector product from each client node:
performing quadratic optimization using the first Hessian-vector product of each client node and the second Hessian-vector product of each client node to generate the plurality of adjusted global learned parameters; and
generating the parameter vector such that the parameter vector comprises the plurality of adjusted global learned parameters.

9. The method of claim 8, wherein performing the quadratic optimization comprises solving the minimization problem:
$$minimize {‖ {\sum }_{i} {α}_{i} {H}_{i} x - {\sum }_{i} {α}_{i} {b}_{i} ‖}_{2}^{2}$$
wherein:
x is the plurality of adjusted global learned parameters;
i is an index value corresponding to a client node of the plurality of client nodes;
αᵢ is a weight assigned to the client node having index value i;
Hᵢx is the second Hessian-vector product obtained from the client node having index value i; and
bᵢ is the first Hessian-vector product obtained from the client node having index value i.

10. The method of claim 2,
wherein the local curvature information obtained from each client node further comprises a gradient vector comprising a plurality of gradients of the objective function of the local model of the respective client node,
the method further comprising, for each client node, storing the gradient vector obtained from the respective client node in the memory as a stored gradient vector of the respective client node.

11. The method of claim 10, wherein processing the local learned parameter information and local curvature information obtained from each client node comprises:
retrieving, from a memory, a plurality of stored global learnable parameters of the global model;
for each local model:
retrieving, from the memory, a stored gradient vector of the respective local model; and
generating an estimated curvature of the objective function of the respective local model based on the local learned parameter information of the respective local model, the gradient vector obtained from the respective client node, the plurality of stored global learnable parameters of the global model, and the stored gradient vector of the respective local model; and
performing quadratic optimization to generate the plurality of adjusted values for the global learnable parameters for the global model based on:
the estimated curvatures of the objective functions of each of the plurality of local models; and
the first Hessian-vector product obtained from each of the plurality of client nodes; and
storing the adjusted values of the global learnable parameters in the memory as the stored global learnable parameters of the global model.

12. The method of claim 11, wherein generating the estimated curvature of a client node comprises applying a quasi-Newton method to generate an estimated Hessian matrix of the local model of the client node based on the gradient vector obtained from the client node, the stored learned values of the global learnable parameters, and the stored gradient vector for the client node.

13. The method of claim 12, wherein performing the quadratic optimization comprises solving the equation:
$$w = {arg min}_{x ∈ {ℝ}^{p}} {‖ {\sum }_{i} {α}_{i} {H}_{i} x - {\sum }_{i} {α}_{i} {b}_{i} ‖}_{2}^{2}$$
wherein:
w is the plurality of adjusted global learned parameters;
i is an index value corresponding to a client node of the plurality of client nodes;
αᵢ is a weight assigned to the client node having index value i;
Hᵢ is a matrix representing the estimated curvature of the objective function of the local model of the client node having index value i; and
bᵢ is the first Hessian-vector product obtained from the client node having index value i.

14. The method of claim 1, further comprising, prior to obtaining the local learned parameter information and local curvature information from the plurality of client nodes:
retrieving, from a memory, a plurality of stored global learned parameters of the global model;
generating global model information comprising the plurality of stored global learned parameters; and
sending the global model information to each client node.

15. A system comprising:
a server, comprising:
a processing device; and
a memory in communication with the processing device, the memory storing:
a global model trained to perform a task, the global model comprising a plurality of stored global learned parameters; and
processor executable instructions for training the global model using federated learning,
the processor executable instructions, when executed by the processing device, causing the server to:
obtain, from each of a plurality of client nodes:
local learned parameter information relating to the plurality of local learned parameters of a respective local model; and
local curvature information of an objective function of the respective local model;
process the local learned parameter information and local curvature information obtained from each client node to generate a plurality of adjusted global learned parameters for the global model; and
store the plurality of adjusted global learned parameters in the memory as the plurality of stored global learned parameters; and
the plurality of client nodes, each client node comprising a memory storing:
a respective local dataset; and
the respective local model, the local model being trained to perform the same task as the global model and comprising the respective plurality of local learned parameters based on the local dataset.

16. The system of claim 15, wherein:
each client node further comprises a processing device;
the memory of each client node further stores processor executable instructions that, when executed by the client's processing device, cause the client node to:
retrieve the plurality of local learned parameters from the memory of the client node;
generate the local curvature information of an objective function of the local model;
generate the local learned parameter information based on the plurality of local learned parameters; and
send the local learned parameter information and local curvature information to the server.

17. The system of claim 16, wherein the local curvature information generated by a respective client node comprises a first Hessian-vector product based on the plurality of local learned parameters of the respective local model and a Hessian matrix, the Hessian matrix comprising second-order partial derivatives of the objective function of the respective local model with respect to the plurality of local learned parameters.

18. The system of claim 17, wherein the local curvature information generated by each client node further comprises a set of diagonal elements of the Hessian matrix of the respective local model.

19. The system of claim 18, wherein:
the local curvature information generated by each client node further comprises a gradient vector comprising a plurality of gradients of the objective function of the local model of the respective client node; and
the server's processor executable instructions, when executed by the server's processing device, further causing the server to, for each client node, store the gradient vector obtained from the respective client node in the server's memory as a stored gradient vector of the respective client node.

20. A server comprising:
a processing device; and
a memory in communication with the processing device, the memory storing:
a global model trained to perform a task, the global model comprising a plurality of stored global learned parameters; and
processor executable instructions for training the global model using federated learning,
the processing device being configured to execute the processor executable instructions to cause the server to:
obtain, from each client node:
local learned parameter information pertaining to a plurality of local learned parameters of a respective local model; and
local curvature information of an objective function of the respective local model;
process the local learned parameter information and local curvature information obtained from each client node to generate a plurality of adjusted global learned parameters for the global model; and
store the plurality of adjusted global learned parameters in the memory as the plurality of stored global learned parameters.
